(19) United States
(12) Patent Application Publication
(10) Pub. No.: US 2026/0240162 A1
(43) Pub. Date: Aug. 20, 2026

(54) COMPOSITIONS AND METHODS FOR ENHANCING PLANT HEALTH AND GROWTH EFFICIENCY

(71) Applicant: Exacto, Inc., Sharon, WI (US)

(72) Inventors: Keith Rowley, Sharon, WI (US); Franklin E. Sexton, Sharon, WI (US); Nongnuch Sutivisedsak, Sharon, WI (US); Glen Obear, Sharon, WI (US); Lia Marchi Werle, Sharon, WI (US); Abdullah Albasri, Sharon, WI (US)

(21) Appl. No.: 19/161,111

(22) PCT Filed: Mar. 1, 2024
(86) PCT No.: PCT/US2024/017990

§ 371 Date: Aug. 29, 2025

Related U.S. Application Data
(60) Provisional application No. 63/487,945, filed on Mar. 2, 2023.

(51) Int. Cl. A01N 57/12; A01P 21/00

(52) U.S. Cl. CPC A01N 57/12; A01P 21/00

(57) ABSTRACT

The present disclosure provides compositions and methods for enhancing plant health and growth efficiency, for example methods comprising applying to a seed, or a plant, a plant part, a propagation material of the plant, or plant growth media an effective amount of ethoxylated lecithin or a composition comprising thereof.

### CROSS-REFERENCE TO RELATED APPLICATIONS

This application claims the benefit of U.S. Provisional Application No. 63/487,945, filed Mar. 2, 2023, the content of which is herein incorporated by reference in its entirety.

### FIELD

The present disclosure relates to methods and compositions for enhancing plant health and growth efficiency.

### BACKGROUND

With the increased demand for high crop productivity, growers have been seeking additional methods to improve plant growth, plant health and overall cropping efficiency. Historically, a wide range of organic and inorganic fertilizer products have been utilized to optimize plant growth efficiency. More recently synthetic plant hormones have been utilized for this purpose. Naturally derived materials, such as plant growth enhancers, or biostimulants, have been extensively studied and applied to cropping systems. Biostimulants provide many of the favorable attributes of traditional plant growth enhancers and have been accepted as alternatives to synthetic products. They have also been considered as synergistic agents of traditional or commonly utilized plant growth enhancers.

Biostimulants may be derived from plants, animals, microorganisms, and other organic carbon sources. Biostimulants are extracted from specific plant species by physical or chemical processes. A common example is the seaweed Ascophyllum nodosum, which has been extracted and widely utilized for its plant growth attributes. This particular seaweed extract contains a complex of organic materials, such as polysaccharides, which positively affect plant growth.

Animal-derived biostimulants can be as simple as cattle manure or more complex, such as chemically hydrolyzed fish parts. These types of animal-derived biostimulants typically contain high levels of amino acids as a result of protein degradation. However, these often possess undesirable odor, a major drawback to their utilization. Amino acids are utilized by plants for a variety of critical growth functions such as protein synthesis.

Another widely used source of biostimulants is microorganisms. These can be bacterial, fungal, or algal in nature. These biostimulants can be applied to plant parts or the growth media to produce a desired plant growth effect. Microorganism-derived biostimulants can be harvested from the microorganism itself or, alternatively, microorganisms can be used to ferment a matrix to produce a broth which possesses desired plant responses.

Fertilizer products are typically derived from non-renewable sources and are often utilized inefficiently by the target plant. Excessive and not absorbed fertilizer are at risk of lixiviation, partially washing away from the soil. These washed off fertilizers often find their way into rivers, streams and ground water creating toxic environments for aquatic species, and in some cases, mammals. The utilization of synthetic plant growth compounds is also challenging given their ability to dramatically impact plant growth and development. Therefore, these compounds can be difficult to use and potentially harmful (e.g., phytotoxic) if used incorrectly.

A more sustainable approach is being sought by people involved in plant growth and care including researchers, agronomists, horticulturalists, and homeowners. The identification and development of a product derived from a sustainable source that effectively enhances plant growth would result in a significant advancement in the quest to improve plant growth, plant health and overall cropping efficiency.

### SUMMARY

Disclosed herein are methods for improving plant growth or promoting plant health, comprising applying to a seed, or a plant, a plant part, a propagation material, or plant growth medium in an early stage of plant growth an effective amount of ethoxylated lecithin or a composition comprising thereof. In some embodiments, the propagation material is a root, a corm, a tuber, a bulb, a slip, a cutting of the plant, and a rhizome. In some embodiments, the early stage of plant growth comprises the seed stage, germination stage, seedling stage, and vegetative stage.

In some embodiments, the applying comprises seed spraying, seed dripping, seed dipping, or seed coating. In some embodiments, the applying comprises irrigating, drenching, spraying, in-furrow application, or direct incorporation into plant growth media.

In some embodiments, the plant growth medium is a soil-based growth medium, a hydroponic growth medium, an aquaponic growth medium, or an aeroponic growth medium.

In some embodiments, the composition comprises about 0.01% v/v to about 99.9% v/v ethoxylated lecithin. In some embodiments, the composition comprises about 0.01% v/v to about 10.0% v/v. In some embodiments, the composition comprises a solvent, diluent, adjuvant, and/or other formulation aid. In some embodiments, the composition further comprises one or more of a fungicide, an insecticide, a miticide, a nematicide, a fertilizer, a nutrient, a mineral, a hormone, a plant growth enhancer, and a stimulant. In some embodiments, the composition does not comprise a fungicide, an insecticide, a miticide, a nematicide, a fertilizer, a nutrient, a mineral, a hormone, a plant growth enhancer, and/or a stimulant.

Also disclosed herein are methods comprising applying an effective amount of ethoxylated lecithin, or a composition thereof, to a plant seed or a plant propagation material. In some embodiments, the method increases germination rate, enhances early health, improves plant growth, and/or improves plant stress resistance in comparison to a plant grown from a seed or plant propagation material not treated with ethoxylated lecithin, or composition thereof.

In some embodiments, the applying comprises seed spraying, seed dripping, seed dipping, or seed coating. In some embodiments, the method further comprises one or both of: drying the seed and storing the seed comprising the ethoxylated lecithin or composition thereof. In some embodiments, the applying is separated from planting of the seed by a period of time. In some embodiments, the period of time is at least a day.

In some embodiments, the applying comprises spraying, dipping, or coating at least a portion of the plant propagation material.

In some embodiments, the composition comprises about 0.01% v/v to about 99.9% v/v ethoxylated lecithin. In some embodiments, the composition comprises about 0.01% v/v to about 10.0% v/v. In some embodiments, the composition comprises a solvent, diluent, adjuvant, and/or other formulation aid. In some embodiments, the composition further comprises one or more of a fungicide, an insecticide, a miticide, a nematicide, a fertilizer, a nutrient, a mineral, a hormone, a plant growth enhancer, and a stimulant. In some embodiments, the composition does not comprise a fungicide, an insecticide, a miticide, a nematicide, a fertilizer, a nutrient, a mineral, a hormone, a plant growth enhancer, and/or a stimulant.

Further disclosed herein are methods to enhance plant growth, crop quality, crop yield or a combination thereof comprising adding an effective amount of ethoxylated lecithin, or a composition comprising thereof, to a growth medium. In some embodiments, the growth medium is a soil-based growth medium, a hydroponic growth medium, an aquaponic growth medium, or an aeroponic growth medium. In some embodiments, the adding comprises irrigating, drenching, in-furrow application, spraying, or direct incorporation.

In some embodiments, the composition comprises about 0.01% v/v to about 99.9% v/v ethoxylated lecithin. In some embodiments, the composition comprises about 0.01% v/v to about 10.0% v/v. In some embodiments, the composition comprises a solvent, diluent, adjuvant, and/or other formulation aid. In some embodiments, the composition further comprises one or more of a fungicide, an insecticide, a miticide, a nematicide, a fertilizer, a nutrient, a mineral, a hormone, a plant growth enhancer, and a stimulant. In some embodiments, the composition does not comprise a fungicide, an insecticide, a miticide, a nematicide, a fertilizer, a nutrient, a mineral, a hormone, a plant growth enhancer, and/or a stimulant.

Methods for preserving the health and stability of a plant or plant part post-harvest are also disclosed herein. The methods comprise providing an effective amount of ethoxylated lecithin, or a composition comprising thereof, to the plant or plant part. In some embodiments, the plant part is selected from a fruit, a flower, flower petals, leaves, roots, tubers, seeds, cuttings, and combinations thereof.

In some embodiments, the providing comprises applying to the surface of the plant or plant part. In some embodiments, the providing comprises fully or partially immersing the plant or plant part in the ethoxylated lecithin, or a composition comprising thereof.

In some embodiments, the ethoxylated lecithin, or a composition comprising thereof, is provided to the plant or plant part immediately preceding harvest or after harvest.

In some embodiments, the composition comprises about 0.01% v/v to about 99.9% v/v ethoxylated lecithin. In some embodiments, the composition comprises about 0.01% v/v to about 10.0% v/v. In some embodiments, the composition comprises a solvent, diluent, adjuvant, and/or other formulation aid.

Additionally disclosed are plant propagation materials or seeds treated with ethoxylated lecithin or a composition comprising thereof and growth media comprising an effective amount of ethoxylated lecithin.

Other embodiments of the disclosure will be apparent in light of the following detailed description.

### BRIEF DESCRIPTION OF THE DRAWINGS

FIGS. 1A-1G are graphs showing mung bean root diameter (FIG. 1A), root volume (FIG. 1B), root length (FIG. 1C), root area (FIG. 1D), root tip count (FIG. 1E), root fork count (FIG. 1F), and root crossing count (FIG. 1G) at 7 days after mung bean bioassay initiation.

FIG. 2 shows the iron content (mg/g) in soybean tissue subjected to in-furrow application of chelated iron and ethoxylated lecithin

FIGS. 3A-3D are graphs showing cherry tomato root volume (FIG. 3A, top), root area (FIG. 3A, bottom), root diameter (FIG. 3B, top), root length (FIG. 3B, bottom), root crossing count (FIG. 3C, top), root tip count (FIG. 3C, bottom), root fork count (FIG. 3D, top), and root dry biomass (FIG. 3D, bottom) at 31 days after initiation.

FIG. 4 shows clipping biomass throughout the turf biomass and quality Improvement study.

FIG. 5 shows corn yield as affected by ethoxylated lecithin treatment (bu/ac).

FIG. 6 shows lettuce yield, measured by head weight, as affected by ethoxylated lecithin application as indicated in Example 10.

### DETAILED DESCRIPTION

The present disclosure provides compositions and methods to enhance plant growth, particularly compositions comprising an ethoxylated phospholipid material which when applied to plants, plant parts, or growth media produces desirable plant growth effects.

Section headings as used in this section and the entire disclosure herein are merely for organizational purposes and are not intended to be limiting.

### 1. DEFINITIONS

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

Unless otherwise defined herein, scientific and technical terms used in connection with the present disclosure shall have the meanings that are commonly understood by those of ordinary skill in the art. The meaning and scope of the terms should be clear; in the event, however of any latent ambiguity, definitions provided herein take precedent over any dictionary or extrinsic definition. Further, unless otherwise required by context, singular terms shall include pluralities and plural terms shall include the singular.

Preferred methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

### 2. ETHOXYLATED LECITHIN FOR PLANT GROWTH

Provided herein are methods and compositions for improving plant growth or promoting plant health.

“Plant health” as used herein means a condition of a plant which is determined by several aspects alone or in combination with each other. One indicator for the condition of the plant is the crop or fruit yield. Crop and fruit include and encompass any plant product which is further utilized after harvesting, e.g., fruits in the proper sense, vegetables, nuts, grains, seeds, wood (e.g., in the case of silviculture plants), flowers (e.g., in the case of gardening plants, ornamentals), and the like. Increased yield of a plant, in particular of an agricultural, silvicultural and/or ornamental plant means that the yield of a product of the respective plant is increased by a measurable amount over the yield of the same product of the plant produced under the same conditions, but without the utilization of the methods described herein. The yield may be increased by at least 0.5%, or by at least 1%, or by at least 2%, or by at least 4%, or by at least 5%, or by at least 10% when compared to appropriate controls.

Another indicator for the condition of the plant is the plant vigor. The plant vigor becomes manifest in several aspects, too, some of which are visual or aesthetic appearance, e.g., leaf color, fruit color and aspect, amount of dead basal leaves and/or extent of leaf blades, plant weight, plant height, extent of plant verse (lodging), number, strongness and productivity of tillers, panicles' length, extent of root system, strongness of roots, extent of nodulation, in particular of rhizobial nodulation, point of time of germination, emergence, flowering, grain maturity and/or senescence, protein content, sugar content and the like. Improved plant vigor means that certain crop characteristics are increased or improved by a measurable or noticeable amount over the same factor of the plant produced under the same conditions, but without the application of ethoxylated lecithin. Improved plant vigor includes, but is not limited to, any of the following improved properties of the plant: improved vitality of the plant, improved quality of the plant and/or of the plant products, e.g., enhanced protein content, improved visual appearance, delay of senescence, enhanced root growth and/or more developed root system (e.g., determined by the dry mass of the root), enhanced nodulation, in particular rhizobial nodulation, longer panicles, bigger leaf blade, less dead basal leaves, increased chlorophyll content, prolonged photosynthetically active period, increased or improved plant stand density, less plant verse (lodging), increased plant weight, increased plant height, tillering increase, stronger and/or more productive tillers, less non-productive tillers, enhanced photosynthetic activity and/or enhanced pigment content and thus greener leaf color, earlier and/or improved germination, improved and/or more uniform and/or earlier emergence, increased shoot growth, earlier flowering, earlier fruiting, earlier grain maturity, increased flowering, increased fruit count, increased root diameter, greater root length or volume, or greater numbers of root tips and forks.

Another indicator for the condition of the plant is the plant's tolerance or resistance to stress (e.g., biotic and abiotic stress factors). Biotic stress is a stress that occurs as a result of damage done to an organism by other living organisms such as microorganisms (e.g., fungi, bacteria, viruses, viroids, phytoplasma, and nematodes), beneficial and harmful insects, or other plants (e.g., weeds or cultivated plants). Abiotic stress factors are non-living factors and include, but are not limited to, low or high temperature, deficient or excessive water, high salinity, heavy metals, and ultraviolet radiation.

In some embodiments, improving plant growth or promoting plant health may be characterized by enhanced root growth, increased blossom formation, increased fruit number, improved overall aesthetics of the plant, increased fruit size, increased plant size, increase leaf surface area, enhanced rate or reliability of germination, increased early plant establishment, increased root number, increased root length, increased root volume/mass, and the like. In some embodiments, improving plant growth or promoting plant health may be characterized by increased water use efficiency. In some embodiments, improving plant growth or promoting plant health may be characterized by increased nutrient uptake.

The methods comprise treating a seed, the plant, a plant part, a propagation material of the plant, or plant growth media with an effective amount of ethoxylated lecithin or a composition comprising thereof. The term “plant propagation material” refers to generative parts of a plant, which can be used for the multiplication of the plant, and vegetative plant material such as cuttings and tubers (e.g., potatoes). In some embodiments, the propagation material is a root, a corm, a tuber, a bulb, a slip, a cutting of the plant, and a rhizome. As such, the disclosure also provides for a plant propagation material or seed treated with ethoxylated lecithin or a composition comprising thereof.

Parts of a plant are any sections of a plant (e.g., roots, cotyledons, tendrils, leaves, flowers, seeds, stems, callus tissue, nuts, and fruit) that develop from a plant propagation material or grow at a later time. The methods described herein can be used on any plant part. Examples of plant parts include but are not limited to the root, corm, tuber, bulb, slip and rhizome.

In some embodiments, the ethoxylated lecithin, or a composition thereof, is applied during or in an early stage of plant growth. The early stage of plant growth may include any stage prior to reproductive stage or mature plant stage. Early stages of plant growth comprise seed, germination, seedling and vegetative or growth stages. The germination or sprouting stage is the stage at which the plant grows from the seed and starts to produce plant parts recognizable as roots. The seedling stage occurs after the plant has sprouted and begun to produce parts recognizable as leaves and stems. During the vegetative stage, the plant produces more foliage and grows from a seedling to an adult plant capable of reproduction.

In some embodiments, the ethoxylated lecithin, or a composition thereof, is applied during or in a late stage of plant growth. Late stages of plant growth include reproductive or otherwise mature plant stages. Late stages of plant growth include, for example, budding, flowering, ripening, and harvesting stages. When the methods are applied in late stages of plant growth, application methods include adding to a plant growth medium, pipetting (e.g., pipetting onto soil, pipetting onto plants or plant parts), irrigating, drenching, painting on plant parts or surfaces. In some embodiments, for late stages of plant growth, the ethoxylated lecithin is not applied by spraying or foliar spraying. In some embodiments, when the methods are applied in late stages of plant growth, the plants do not include crop plants (e.g., grain crops, fruit crops, forage crops, root vegetable crops, leafy vegetable crops, flowering plants, oil crops, industrial crops, medicinal crops).

In some embodiments, the ethoxylated lecithin, or a composition thereof, is applied immediately preceding harvest or any time after harvest to promote post-harvest health and stability. As such, also provided herein are methods and compositions for preserving health and stability of a plant or plant part (e.g., a fruit, a flower, flower petals, leaves, roots, tubers, seeds, cuttings, and combinations thereof) post-harvest. Post-harvest broadly encompasses any time following harvesting. Preserving the health and stability of a plant or plant part post-harvest may specifically comprise suppression of biological infestation of a pest or pathogen and/or diseases, preventing damage to the plant or plant part, increasing stability under various atmospheric (e.g., temperature and humidity) conditions, or otherwise safeguarding the health of the plant or plant part during periods of storage and/or transport.

The methods disclosed herein are suitable for use with any plant, for example, grain crops, fruit crops, forage crops, root vegetable crops, leafy vegetable crops, flowering plants, conifers, trees, oil crops, plants used in phytoremediation, industrial crops, medicinal crops, laboratory model plants, and the like. As such, non-limiting examples of plants that may be used with the present methods include: grains, forage crops, fruits, vegetables, oil seed crops, palms, forestry, vines, maize (corn, Zea mays), banana, peanut, field peas, sunflower, tomato, canola, tobacco, wheat, barley, oats, potato, soybeans, cotton, carnations, sorghum, lupin, rice, rutabaga, celery, switchgrass, apple, petunias, Arabidopsis thaliana, Medicago truncatula, Medicago sativa, Brachypodium distachyon, Nicotiana benthamiana, or Setaria viridis.

Exemplary plants that can be treated using the methods disclosed herein include but are not limited to the following monocots and dicots: bulb vegetables; cereal grains (such as wheat, barley, rice; corn; citrus fruits (such as grapefruit, lemon, and orange); cotton and other fiber crops; cucurbits; fruiting vegetables; leafy vegetables (such as celery, head and leaf lettuce, and spinach); legumes (such as soybeans, green beans, chick peas, lentils); oil seed crops; peanut; pome fruit (such as apple and pear); stone fruits (such as almond, pecan, and walnut); root vegetables; tuber vegetables; corm vegetables; tobacco; strawberry and other berries; cole crops (such as broccoli, cabbage); grape; plants used for biomass production (such as miscanthus, bamboo); pineapple; flowering plants; bedding plants; grasses; and perennial plants, including plantation crops such as banana and coffee. The methods described herein are also suitable for ornamental plants. Ornamental plants include but are not limited to the plants which are grown in greenhouses, nurseries, urban and suburban greenspaces, landscaped areas and properties, home properties, parks, vertical farming, hydroponic operations, and hoop houses. The plants within the ornamental market are varied and broad, but generally contain non-turf and non-food plants primarily grown for aesthetic or utility purposes.

The methods described herein are also suitable for turf. Turf includes but is not limited areas where turfgrass and other amenity crops are grown, including golf courses, athletic fields, roadsides, rights of way, home lawns, commercial and industrial properties, greenways, parks, airport surrounds, and urban and suburban greenspaces. As such, turf comprises a contiguous community of plants that can withstand traffic and repeated defoliation. Turf species are adapted to a wide range of climatic conditions; warm-season C4 grasses such as bermudagrass and zoysiagrass thrive in the southern and western United States. Cool-season C3 grasses such as bentgrass, Kentucky bluegrass, and perennial ryegrass thrive in moderate mid-latitude and cool northern climates.

The ethoxylated lecithin may be derived from a variety of sources. The methods disclosed herein are not limited by the source of ethoxylated lecithin.

In some embodiments, the ethoxylated lecithin is produced by the reaction of crude soybean lecithin and ethylene oxide, as described in U.S. Pat. No. 2,310,679, incorporated herein by reference. Ethoxylated lecithin is commercially available, for example, Eucarol NA-6415 and ETMA NA-6416 from Lamberti USA Inc. in Conshohocken, PA, and VITEX from Exacto, Inc. in Sharon, WI. Ethoxylated lecithin from these commercial sources is presumably ethoxylated crude soybean lecithin, also referred to as phospholipid-enriched soybean oil, obtained from ethoxylating a crude soybean lecithin containing from 5-30 wt %, preferably 8-10 wt %, and more preferably about 10 wt % phospholipids. The crude soybean lecithin is a fluid under ambient temperature and pressure. Ethoxylation may be carried out according to the process of U.S. Pat. No. 2,310,679 without the presence of an inert solvent. Triglycerides contained in the soybean oil may include, for example, C16 saturated and C18 saturated, monounsaturated and polyunsaturated fatty acids, particularly palmitic, stearic, oleic, linoleic, and linolenic acid, with an iodine value of 120-140. The crude soybean lecithin is reacted with 30-90 wt %, preferably 50-70 wt % ethylene oxide between 90-180° C. in the presence of a basic catalyst such as potassium hydroxide, at a pressure between 1 and 5 bar for 60-300 minutes. Small amounts of glycerol (e.g., 1-4 wt %) may be added as an initiator. The reaction conditions (e.g., time and pressure) may be set to obtain a final product comprising 10-200 ethylene oxide units with an ideal amount of 20-50 ethylene oxide units. Temperature is preferably maintained below 170° C. (ideally at ~160° C.) to avoid excessive discoloration. For example, preferred ethoxylated lecithin may be phospholipids having 25 moles ethoxylate functional group incorporated therein (having a number average molecular weight (NAVG MW) of about 1000) and/or lecithin having 30 moles ethoxylate functional group incorporated therein (having a NAVG MW of about 1200). The ethoxylated lecithin for use in the disclosed methods and compositions is not limited to any particular molar amounts or NAVG MW.

Ethoxylated lecithin can also be derived from crude lecithin from other seed oil crops as well as lecithin derived from chicken eggs. Additionally, ethoxylated lecithin can be derived from any source that has an enriched source of phospholipids.

### a) Compositions

In some embodiments, the ethoxylated lecithin is provided to a seed, or the plant, a plant part, a propagation material of the plant, or plant growth media as a composition. The composition may comprise other active agents which aid in improving plant growth or promoting plant health, agents which aid and assist in the application of the ethoxylated lecithin (e.g., stabilizers, fillers, matrix elements, carriers), or act as a solvent or diluent for the ethoxylated lecithin (e.g., to achieve the desired concentration necessary for the desired application method). The composition may be liquid or solid. The composition may be in the form of an immediate release composition or a slow or controlled release composition.

In some embodiments, the ethoxylated lecithin is applied as a mixture of ethoxylated lecithin and solvent(s). The concentration of the ethoxylated lecithin in the mixture may range from about 0.01% v/v to about 99.9% v/v. The concentration of the ethoxylated lecithin in the mixture may be about 0.01% v/v, about 0.02% v/v, about 0.03% v/v, about 0.04% v/v, about 0.05% v/v, about 0.06% v/v, about 0.07% v/v, about 0.08% v/v, about 0.09% v/v, about 0.1% v/v, about 0.2% v/v, about 0.3% v/v, about 0.4% v/v, about 0.5% v/v, about 0.6% v/v, about 0.7% v/v, about 0.8% v/v, about 0.9% v/v, about 1.0% v/v, about 2.0% v/v, about 5.0% v/v, about 10.0% v/v, about 15.0% v/v, about 20.0% v/v, about 25.0% v/v, about 30.0% v/v, about 35.0% v/v, about 40.0% v/v, about 45.0% v/v, about 50.0% v/v, about 55.0% v/v, about 60.0% v/v, about 65.0% v/v, about 70.0% v/v, about 75.0% v/v, about 80.0% v/v, about 85.0% v/v, about 90.0% v/v, about 95.0% v/v, about 98.0% v/v, or about 99.0% v/v.

In select embodiments, the concentration of the ethoxylated lecithin in the mixture is between about 0.01% v/v and 10.0% v/v. The concentration of the ethoxylated lecithin in the mixture may be between about 0.01% v/v and 8.0% v/v, about 0.01% v/v and 6.0% v/v, about 0.01% v/v and 4.0% v/v, about 0.01% v/v and 2.0% v/v, about 0.01% v/v and 1.0% v/v, about 0.01% v/v and 0.1% v/v, about 0.01% v/v and 0.05% v/v, about 0.05% v/v and 10.0% v/v, about 0.05% v/v and 8.0% v/v, about 0.05% v/v and 6.0% v/v, about 0.05% v/v and 4.0% v/v, about 0.05% v/v and 2.0% v/v, about 0.05% v/v and 1.0% v/v, about 0.05% v/v and 0.1% v/v, about 0.1% v/v and 10.0% v/v, about 0.1% v/v and 8.0% v/v, about 0.1% v/v and 6.0% v/v, about 0.1% v/v and 4.0% v/v, about 0.1% v/v and 2.0% v/v, about 0.1% v/v and 1.0% v/v, about 0.5% v/v and 10.0% v/v, about 0.5% v/v and 8.0% v/v, about 0.5% v/v and 6.0% v/v, about 0.5% v/v and 4.0% v/v, about 0.5% v/v and 2.0% v/v, about 0.5% v/v and 1.0% v/v, about 1.0% v/v and 10.0% v/v, about 1.0% v/v and 8.0% v/v, about 1.0% v/v and 6.0% v/v, about 1.0% v/v and 4.0% v/v, about 1.0% v/v and 2.0% v/v, about 2.0% v/v and 10.0% v/v, about 2.0% v/v and 8.0% v/v, about 2.0% v/v and 6.0% v/v, about 2.0% v/v and 4.0% v/v, about 4.0% v/v and 10.0% v/v, about 4.0% v/v and 8.0% v/v, about 4.0% v/v and 6.0% v/v, about 6.0% v/v and 10.0% v/v, about 6.0% v/v and 8.0% v/v, or about 8.0% v/v and 10.0% v/v.

The compositions are not limited by the type of solvent(s). Exemplary solvents include, but are not limited to: water; monoethylene glycol; diethylene glycol; propylene glycol or the methyl, ethyl, n-propyl, n-butyl or t-butyl ethers thereof; dipropylene glycol or the methyl, ethyl, n-propyl, n-butyl, or t-butyl ethers thereof; tripropylamine glycol or the methyl, ethyl, n-propyl, n-butyl, or t-butyl ethers thereof; 1,3 butanediol; 1,4 butanediol; 2-methyl, 1,3-propanediol; 2,2-methyl-1,3-propanediol; 2-methyl-1,3-pentanediol; 2-methyl-2,4-pentanediol; glycerol; and sorbitol. In select embodiments, the solvent comprises water.

The solvent is not limited to those agents acting only for dissolution of the ethoxylated lecithin. The solvent(s) may contribute to other properties of the composition in addition to being used as a solvent or co-solvent. For example, the solvent may improve or influence dispersion, stability, activity, handling, application, deposition, and/or efficacy of the composition.

The compositions may further comprise a nonionic surfactant (e.g., alkyl polyglycosides), an anionic surfactant, and/or a zwitterionic surfactant. Exemplary nonionic surfactants include without limitation: Cetomacrogol 1000; cetostearyl alcohol; cetyl alcohol; cocamide diethanolamine; cocamide monoethanolamine; decyl glucoside; decyl polyglucose; glycerol monostearate; IGEPAL CA-630; Isoceteth-20; lauryl glucoside; maltoside; monolaurin; mycosubtilin; narrow-range ethoxylate; Nonidet P-40; Nonoxynol-9; Nonoxynols; NP-40; octaethylene glycol monododecyl ether; N-octyl beta-D-thioglucopyranoside; octyl glucoside; oleyl alcohol; pentaethylene glycol monododecyl ether; polidocanol; poloxamer; poloxamer 407; polyethoxylated tallow amine; polyglycerol polyricinoleate; polysorbate; polysorbate 20; polysorbate 80; sorbitan; sorbitan monolaurate; sorbitan monostearate; sorbitan tristearate; stearyl alcohol; surfactin; Triton X-100; and Tween 80.

Exemplary anionic surfactants include without limitation: 2-acrylamido-2-methylpropane sulfonic acid; alkylbenzene sulfonates; ammonium lauryl sulfate; ammonium perfluorononanoate; chlorosulfolipid; disodium cocoamphodiacetate; docusate; magnesium laureth sulfate; MBAS assay; A-Olefin sulfonate; perfluorobutanesulfonic acid; perfluorodecanoic acid; perfluorohexanesulfonic acid; perfluorononanoic acid; perfluorooctanesulfonic acid; perfluorooctanoic acid; phospholipid; potassium lauryl sulfate; soap; soap substitute; sodium dodecyl sulfate; sodium laurate; sodium laureth sulfate; sodium lauroyl sarcosinate; sodium myreth sulfate; sodium nonanoyloxybenzenesulfonate; sodium pareth sulfate; sodium stearate; sodium sulfosuccinate esters; sodium tetradecyl sulfate; and sulfolipid.

Exemplary zwitterionic surfactants include without limitation: CHAPS detergent; cocamidopropyl betaine; cocamidopropyl hydroxysultaine; dipalmitoylphosphatidylcholine; hydroxysultaine; miltefosine; peptitergents; and sodium lauroamphoacetate.

The compositions may further comprise other chemical and non-chemical additives, adjuvants, formulation aids, and/or treatment agents (e.g., to improve dispersion, dissolution, stability, activity, handling, application, deposition, and/or efficacy) including, but not limited to: chemical and non-chemical fungicides, insecticides, miticides, nematicides, fertilizers, nutrients, minerals, hormones (e.g., auxins, cytokinins, gibberellins, ethylene, and abscisic acid), plant growth enhancers or stimulants, wetting agents, spreading agents, dispersing agents, adhesive agents, buffering agents, coating agents, resins, suspension agents, stickers, penetrants, and the like.

Exemplary fungicides include, but are not limited to: thiabendazole; iprodione; vinclozolin; imazilil; triforine; fenarimol; bitertanol; cyproconazole; difenoconazole; fenbuconazole; flusilazole; ipconazole; metconazole; myclobutanil; propiconazole; prothioconazole; tebuconazole; tetraconazole; triadimefon; triadimenol; triticonazole; metalxyl; mefenoxam; cyprodinil; azoxystrobin; picoxystrobin; pyraclostrobin; etridiazole; fenhexamid; polyoxin; fluazinam; dimethomorph; acibenzolar-S-methyl; chlorothalonil; chloroneb; dicloran; quintozene (PCNB); famoxadone; fenamidone; mineral oils; organic oils.

Exemplary nematicides include, but are not limited to, 1,3 dichloropropene, chloropicrin, metam sodium, metam potassium, dimethyl disulfide, allyl isothiocyanate, oxamyl, fluensulfone, fluopyram, ethoprop, spirotetramat, terbufos, and fluazaindolizine.

Exemplary insecticides and miticides include, but are not limited to: acephate, aldicarb, azinphos methyl, Bacillus thuringiensis, carbaryl, chlorpyrifos, cyhexatin, cypermethrin, diazinon, dicofol, dicrotophos, diflubenzuron, dimethoate, disulfoton, endosulfan, Ethion, fluvalinate, fonofos, formetanate hydrochloride, lindane, malathion, methamidophos, methidathion, methomyl, methoxychlor, methyl parathion, mevinphos, naled, oxamyl, oxythioquniox, parathion, permethrin, phorate, phosmet, profenofos, propargite, sulprofos, thiodicarb, and trichlorfon.

Fertilizers can be organic, or inorganic. They can be naturally occurring compounds such as peat or mineral deposits, manufactured through natural processes such as composting, or manufactured through chemical processes. Thus, the term “fertilizer” as used herein, refers to any substance which, when applied to a substrate, e.g., soil, leaves, hydroponic solution etc., enriches or fertilizes that substrate by providing nutrients for the plant's, necessary biological functions, e.g., growth, flowering etc. In an exemplary embodiment, a fertilizer comprises plant nutrients in the form of agricultural waste products, e.g., manure, grass clippings, compost. In another exemplary embodiment, a fertilizer comprises a synthetic blend of various chemical substances known in the art as plant nutrients, e.g., blends comprising at least one or more of nitrogen, potassium, and/or phosphorus. In yet other exemplary embodiments, a fertilizer comprises a combination of agricultural waste products and synthetic chemicals which, when applied to a substrate, enriches or fertilizes that substrate. Fertilizers may contain, but are not limited to, sources of macronutrients (nitrogen, phosphorous, and potassium), secondary macronutrients (calcium (Ca), magnesium (Mg) and sulfur(S)), and micronutrients (boron (B), copper (Cu), iron (Fe), manganese (Mn), molybdenum (Mo) and zinc (Zn)).

Hormones, growth stimulants and the like include, but are not limited to: trinexepac-ethyl, gibberellic acid, gibberellins, cytokinins, benzyladenine, glycines, quinolenes, phosphoric acid compounds, organic carbamates, quaternary ammonium compounds, acetamides, ethychlozate, azoles, paclobutrazol, anilides, pyradazidine, pyrimidines, napthaleneacetamide, phthalmides, phenoxies, pyrimidines, biostimulants, seaweed extracts, phthalmides, phenoxies, steroids (e.g., brassinosteroids) and organic or carboxylic acids (e.g. gamma amino butyric acid and L-glutamic acid, Napthalene acetic acid, Clofencoet, Sintofen, nicotinic acids).

Other pesticides, protectants and/or beneficial agents which may find use in the compositions disclosed herein include, animal and bird repellants, bitter flavors, irritants, and malodorous ingredients, Molluscicides (e.g., slugs and snails), Rodenticides, Chemosterilants, plant defense boosters (Harpin protein and Chitosan), frost prevention aids, UV protectants, antioxidants, moisture retention aids, humic acids and humates, and lignins and lignates.

In some embodiments, the compositions may be formulated as slow or controlled release by use of a wide variety of coatings and matrices mediated by controlled release polymers including, but not limited to, polyolefins, polyolefin elastomers polyvinylidene chloride, and copolymers thereof, starch, cellulose, lignin, alginates, chitosan, and the like.

In some embodiments, the compositions comprise a seed, or a plant, a plant part, a propagation material of the plant, or plant growth media in contact with ethoxylated lecithin and/or other components described herein. For example, in some embodiments, a composition comprises a seed coated with ethoxylated lecithin and/or other component described herein.

### b) Application Methods

As used herein, the term “applying” in reference to the ethoxylated lecithin, or composition thereof, refers to any means for treating seeds, growth medium, and plants or plant parts with ethoxylated lecithin or compositions thereof, for example, seed dipping, hydroseeding, soil drench, pipetting onto soil or plant/plant parts, irrigating plants, spraying, and the like. In some embodiments, the applying comprises seed dipping or spraying, hydroseeding, pipetting (e.g., pipetting onto soil, pipetting onto plants or plant parts), irrigating, drenching, spraying, foliar spraying, or a combination thereof. The ethoxylated lecithin or compositions thereof can be applied in any way to enhance plant growth and plant productivity. The ethoxylated lecithin or compositions thereof can be applied undiluted or diluted. The dilution and rate of application may be adjusted depending upon the type of application methods used. The application may be performed once or at multiple time points (e.g., at different stages of plant growth or set time periods (e.g., once a day, once a week, etc.)).

Irrigation systems and methods that deliver water, often containing plant nutrients and other agents, to plants via networks of irrigation pipes or hoses are very well known, in a process sometimes referred to as chemigation or fertigation. In many such irrigation systems and networks, solution from the pipes or hoses is delivered to the plants by emitters or drippers that are installed on or integrated in the irrigation pipes or hoses. In the methods herein, the ethoxylated lecithin, or compositions thereof, may be added directly to water irrigation solution, continuously or in bolus amounts at distinct times during plant growth, or be delivered separately by similar irrigation methods as desired.

Spraying may be directed towards any part of the plant including the foliage, base of the stems, branches, roots, spraying onto the surface of soil, spraying plant seeds, or spraying at the base of the plants by any industrial or home use methods. The ethoxylated lecithin, or composition thereof, may be applied by spraying methods commonly employed, such as conventional high-gallonage hydraulic sprays, low-gallonage sprays, air-blast, aerial sprays, and dusts. The methods may alternatively employ electrodynamic spraying techniques or other low volume methods or applied by land or aerial irrigation systems.

The ethoxylated lecithin, or composition thereof, may be applied to seeds in several ways, including spraying, dripping, or dipping. Spray and drip applications may be conducted by spraying or dripping the ethoxylated lecithin, or composition thereof, onto a seed(s) via a continuous system (which is calibrated to apply the ethoxylated lecithin, or composition thereof, at a predefined rate in proportion to the continuous flow of seed). Batch systems, in which a predetermined batch size of seed and ethoxylated lecithin, or composition thereof, are delivered into a mixer, may also be employed. Systems and apparatus for performing these processes are commercially available.

In another embodiment, the applying may comprise coating seeds with the ethoxylated lecithin, or composition thereof. An exemplary process includes coating the inside wall of a round container with the ethoxylated lecithin, or composition thereof, adding seeds, then rotating the container to cause the seeds to contact the wall and the composition, a process known as container coating. Seeds can be coated by any combinations of coating methods.

Seed dipping refers to application of the ethoxylated lecithin, or composition thereof, directly to a seed, such as soaking a seed for few seconds, minutes, or hours in a liquid formulation of the ethoxylated lecithin, or composition thereof. For example, seeds can be dipped or soaked for about 1 minute to about 24 hours (e.g., for at least 1 min, 5 min, 10 min, 20 min, 40 min, 80 min, 3 hr, 6 hr, 12 hr, 24 hr). Seed dipping may also refer to application of a dried formulation of the ethoxylated lecithin, or composition thereof.

The seed following the application of the ethoxylated lecithin, or composition thereof, may be dried and/or stored prior to planting. For example, the seed may be treated, optionally dried, and stored for at least one day (e.g., at least one week, at least two weeks, at least three weeks, at least one month, at least two months, at least four months, at least six months, at least one year, or more) prior to planting. The drying may be an active process, such as by use of heat and or forced air, or a passive process by slow evaporation over time (e.g., while in storage). Alternatively, in some embodiments, the seed is treated immediately preceding planting.

In another embodiment, the applying may comprise applications at the time of seeding such as hydroseeding, spraying seeds after planting, or broadcasting. Hydroseeding is used for seeding large areas, for example grass seeding of golf courses, parks, and the like. Hydroseeding may be used to seed largely inaccessible areas or areas in need of soil erosion control, for example steeply sloped areas, burn scars, and construction sites. Hydroseeding generally is performed by dispersing a hydroseed composition or slurry, which includes seeds, water, a hydroseeding substrate (e.g., mulch, clay, polymers, starch, and the like), and other additives (e.g., fertilizers, dyes) from a hose or a spray turret of a hydroseeding machine or, for large-scale dispersion, tankers or helicopters. Thus, in some embodiments, the ethoxylated lecithin may be a component of the hydroseed composition or slurry or added with the hydroseed composition or slurry at the end of the hose or spray turret.

In some embodiments, the applying comprises adding to a plant growth medium including liquid or dry in-furrow application, spraying across the area of soil in which seeds will be planted, drenching of potted plants, direct incorporation into soils, greenhouse planting mixes, or other plant growth media (hydroponic, aquaponic, or aeroponic growth media), or application of granular formulations or granules. As such, the disclosure also provides plant growth media (e.g., soils, greenhouse planting mixes, or other plant growth media (hydroponic, aquaponic, or aeroponic growth media)) comprising an effective amount of ethoxylated lecithin.

Application of the ethoxylated lecithin, or composition thereof, to soil-based growth mediums may take many forms. Applying in-furrow is the practice of placing directly on or near the seed in-furrow at planting. Alternatively, the ethoxylated lecithin, or composition thereof, can be applied on the top of the soil surrounding the plant, for example, as a liquid or granular formulation. As an additional alternative, soil incorporation is a method of application which physically mixes the ethoxylated lecithin, or composition thereof, in the soil layer, particularly where it is most efficacious for inclusion (e.g., top two to three inches of soil or rhizosphere) rather than applying to the soil surface or placing in furrow. Soils, particularly soils in containers (e.g., pots, bags, starter or nursery pots, tree pots, planters, seedling trays), may also be drenched with the ethoxylated lecithin, or composition thereof. Prepackaged greenhouse mixes and commercially available soils may be pretreated with liquid or solid forms of ethoxylated lecithin prior to use in fields, beds, containers, and the like.

Non-soil plant growth media, including hydroponic growth media, aquaponic growth media, or aeroponic growth media are also suitable for use with the ethoxylated lecithin, or compositions thereof, in the methods disclosed herein.

Hydroponics is a method of growing plants in a water-based, nutrient-rich growth medium. Hydroponic systems do not use soil, instead the root system is supported using an inert medium such as perlite, rock wool, clay pellets, peat moss, or vermiculite. In the methods herein, the ethoxylated lecithin, or compositions thereof, may be added directly to the water-based nutrient solution. The hydroponic growth medium may further comprise macronutrients (e.g., sodium, potassium, phosphorous) and other secondary and micronutrients (e.g., calcium, magnesium, sulfur, boron copper, zinc, etc.).

Aquaponics involves the symbiotic integration of the growth of aquatic species with the growth of plants, wherein the waste products from the aquatic species act as nutrients for the plant species. In utilizing the nutrient-rich waste of the aquatic species, the plants at least partially cleanse the circulating water, preserving the system's suitability for the survival of the aquatic species. In the methods herein, the ethoxylated lecithin, or compositions thereof, may be added directly to the water (e.g., at onset and/or regularly input, as batch-wise or continuous additions, while the system is actively being used to grow plants).

Aeroponics is a process of growing plants without soil, where the plant's roots are suspended in air and receive moisture from mist or other water/solution distribution methods. Aeroponics systems incorporate misters or nebulizers that provide water and other nutrients to the root and shoots in a mist or aerosol from one or more colloid or solution fluid sources. Aeroponics systems may have a single fluid source for delivery of the water and nutrients or two different fluid sources for delivering water and the nutrients to the roots. In the methods herein, the ethoxylated lecithin, or compositions thereof, may be added to either or both of the water or nutrient sources, the single combined source, or may be delivered via a dedicated source.

In some embodiments, the ethoxylated lecithin or compositions thereof are applied in rotation with other treatments. In some embodiments, the ethoxylated lecithin or compositions thereof are applied to plants at the same time as the other treatments.

Post-harvest application methods include standard treatment methods of: dipping, drenching, full or partial immersion, brushing, fumigating, painting, fogging, spraying, dusting, vaporizing, atomizing, broadcasting, or otherwise contacting the plant or plant-part with the ethoxylated lecithin, or a composition thereof.

### c) Kits

In another aspect, the disclosure provides kits comprising a composition or growth medium comprising ethoxylated lecithin and instructions for use. The kits can also comprise other agents and/or products co-packaged, co-formulated, and/or co-delivered with other components.

The kits can also comprise instructions for using the components of the kit. The instructions are relevant materials or methodologies pertaining to the kit. The materials may include any combination of the following: background information, list of components, brief or detailed protocols for using the compositions, troubleshooting, references, technical support, and any other related documents. Instructions can be supplied with the kit or as a separate member component, either as a paper form or an electronic form which may be supplied on computer readable memory device or downloaded from an internet website, or as recorded presentation.

It is understood that the disclosed kits can be employed in connection with the disclosed methods. The kit may further contain containers or devices for use with the methods or compositions disclosed herein. For example, the disclosed kit may further provide a means to apply the composition comprising ethoxylated lecithin (e.g., a sprayer or spray bottle, a pipette, etc.).

In some embodiments, the kit comprises a seed, a plant, a plant part, a propagation material of a plant, or plant growth media. In some embodiments, the kit comprises seed pods or other devices that hold seeds.

The kits provided herein are in suitable packaging. Suitable packaging includes, but is not limited to, vials, bottles, jars, flexible packaging, and the like. Individual member components of the kits may be physically packaged together or separately.

### 3. EXAMPLES

### Example 1

### Foliar Application of Ethoxylated Lecithin

The effects of a foliar application of ethoxylated lecithin (Lamberti) on vegetative growth and early reproductive bush beans was studied in comparison to a commercial plant growth regulator, Ascend (Winfield United, River Falls, WI).

Three bush bean seeds (Phaseolus vulgaris var. Accelerate) were planted in 1-liter pots filled with Fertilome professional potting mix. Seeds were allowed to germinate under artificial light 13:11 h L:D photoperiod at 25° C. Plants were thinned to 1 plant per pot 1 week after emergence. Plants were watered as needed. The fertilized group (treatment 4) was fertilized twice per week with a customized NPK+micronutrients mixture. Two foliar applications of the treatments were performed. The first application (A) occurred when plants reached the V1 stage (e.g., first trifoliate fully expanded) with the second application (B) at 2 weeks after A. Plants were sprayed inside a spray chamber using a single even nozzle (medium droplet size). Treatments were applied at a rate of 15 gallons per acre (15 gpa). Study was terminated once plants entered the reproductive stage and pods began to form.

### Treatments

| Treatment | Product | Rate (% v/v) |
|---|---|---|
| 1 | Ascend | 0.18 |
| 2 | Ethoxylated Lecithin | 0.0747 |
| 3 | Ascend + Ethoxylated Lecithin | 0.18 + 0.0747 |
| 4 | Fertilizer (no foliar treatment) | Standard crop care |
| | | (NPK + micronutrients) |
| 5 | Untreated | 0 |

Flower count was significantly higher in plants treated with ethoxylated lecithin. Plants treated with Ascend showed no statistical difference in flower count compared to untreated. Plants treated with Ascend+ethoxylated lecithin showed no difference in flower count in comparison to those that received ethoxylated lecithin treatment alone. Fruit count was positively impacted by ethoxylated lecithin. Plants treated with Ascend+ethoxylated lecithin showed no difference in fruit count compared to those treated with ethoxylated lecithin alone. A possible compensation effect may have occurred due to lack fertilizer (energy allocation). Above ground biomass was not impacted. Fertilized plants absorbed more moisture (fresh weight significant impact) but dry weight was not impacted. Nutrition may have impacted on above ground biomass.

A second study was completed with Treatments 1-3 and 5, as outlined above, with one change to the protocol. In the second study, plants were fertilized twice per week with a customized liquid fertilizer and watered daily.

Flower count was significantly higher in plants treated with ethoxylated lecithin plus Ascend (treatment 3). Fruit count was positively impacted by ethoxylated lecithin plus Ascend. Ascend plus ethoxylated lecithin treatment did not alter fruit count compared to ethoxylated lecithin alone. Possible compensation effect due to lack fertilizer (energy allocation). Fresh weight of above ground biomass was positively impacted by ethoxylated lecithin plus Ascend. The dry weight of above ground biomass was similar for all treatments, indicating that plants of the given treatment were able to absorb more moisture. Overall, there was evidence of synergism between ethoxylated lecithin and Ascend (treatment 3).

### Example 2

### Root Development in Hydroponics

The effects of ethoxylated lecithin (Lamberti) were compared to a commercial seaweed biostimulant, Toggle (Winfield United, River Falls, WI) utilizing a mung bean bioassay and the WinRHIZO root scanning system.

The mung bean bioassay was designed to compare root development as a result of hydroponically treating mung bean shoots. The mung bean shoots were sampled and analyzed after 7 and 14 days. The mung bean bioassay protocol is as follows:

SEED GERMINATION Fertilome Professional potting mix was used to grow mung bean plants for the following studies. The mix contained sphagnum peat moss, coarse perlite, dolomitic limestone, calcitic limestone, starter nutrient charge and a wetting agent. The mixes were mixed with deionized water and added into a seed tray. A 200 cell plug tray was used to evenly plant mung bean seeds. The seeds were covered with about 1.5 L of the soil mixture and watered in with 600 mL of distilled water. Trays were kept inside a growth chamber at 25° C. with a 13:11 h Light:Dark photoperiod.

SEEDLING TRANSFER The studies were initiated when seedlings were at VC stage (unifoliate fully expanded; ~5-7 days after seeding). Seedlings were cut off at soil level and cotyledons carefully removed by twisting off in an upward pulling motion. Using a ruler or marked cutting board, the hypocotyls are cut exactly 4 cm below the cotyledons using a razor-sharp scalpel blade. Seedlings were placed in 20 ml scintillation vials containing 12 ml of the treatment solution and maintained inside a growth chamber for the duration of the study.

ROOT SCAN MEASUREMENT A WinRHIZO root scanner is used to scan the roots after one week of growth (see WinRHIZO root scanner manual). The plants are cut to the top root from the bottom of the stem and all 10 plants from each treatment are scanned together. Root Length, Surface Area, Volume and Average Diameter were graphed to compare each treatment along with the controls.

### Treatments

| Treatment | Product | Rate (% v/v) |
|---|---|---|
| 1 | Toggle | 0.60 |
| 2 | Ethoxylated Lecithin | 0.0747 |
| 3 | Toggle + Ethoxylated Lecithin | 0.60 + 0.0747 |
| 4 | Untreated | 0 |

Untreated seedlings did not grow roots past the 7-day after study initiation. The plants in this group exhibited the largest root diameter of all treatments and exhibited significantly less forks, tips, crossings than other treatments.

Ethoxylated Lecithin and Toggle exhibited similar effects on root development and root morphology. The Toggle plus Ethoxylated Lecithin mixture showed an additive effect on root tips & forks compared to the other treatments. The Toggle plus Ethoxylated Lecithin mixture showed a synergistic effect on the root crossings compared to the other treatments.

The rate response of ethoxylated lecithin on root development was studied utilizing seven rates of Ethoxylated Lecithin in the mung bean bioassay protocol described above. The root morphology quantified after 7 days by WinRHIZO was compared between treatments.

### Treatments

| Treatment | Product | Rate (% v/v) |
|---|---|---|
| 1 | Ethoxylated Lecithin | 0.0093 |
| 2 | Ethoxylated Lecithin | 0.0187 |
| 3 | Ethoxylated Lecithin | 0.0374 |
| 4 | Ethoxylated Lecithin | 0.0747 |
| 5 | Ethoxylated Lecithin | 0.1494 |
| 6 | Ethoxylated Lecithin | 0.2988 |
| 7 | Ethoxylated Lecithin | 0.5976 |
| 8 | Untreated | 0 |

Treatments 1-6 exhibited greater root length compared to the untreated. All ethoxylated lecithin treatments exhibited greater root area compared to the untreated. Treatments 6 and 7 exhibited greater root diameter compared to the untreated. Treatments 2-7 exhibited greater root volume compared to the untreated. All ethoxylated lecithin treatments exhibited greater numbers of root tips and forks compared to the untreated. Treatments 2-5 exhibited measurable root crossings whereas all other treatments showed no measurable root crossings. Treatments 2-5 were the preferred rate range for effective root growth stimulation.

The rate response of ethoxylated lecithin from multiple sources on root development was studied utilizing two alternative sources of Ethoxylated Lecithin, Alternative Source 1 (Lamberti) and Alternative Source 2 (Exacto) as listed below for Treatments 5 and 6, in addition to the ethoxylated lecithin from above and Example 1 (Treatments 1-4), in the mung bean bioassay protocol described above. The root morphology quantified after 7 and 14 days by WinRHIZO was compared between treatments.

### Treatments

| | | Rate |
|---|---|---|
| Treatment | Product | (% v/v) |
| 1 | Ethoxylated Lecithin | 0.0093 |
| 2 | Ethoxylated Lecithin | 0.0187 |
| 3 | Ethoxylated Lecithin | 0.0374 |
| 4 | Ethoxylated Lecithin | 0.0747 |
| 5 | Ethoxylated Lecithin - Alternative Source 1 | 0.0374 |
| 6 | Ethoxylated Lecithin - Alternative Source 2 | 0.0374 |
| 7 | Untreated | 0 |

All ethoxylated lecithin treatments exhibited lower root diameters compared to the untreated at 7 days. At 14 days, treatment 2 exhibited higher root diameter than the untreated, treatment 1 exhibited similar root diameter to the untreated and other treatments showed lower diameters.

Treatments 3-6 exhibited root volumes at 7 days similar to the untreated. Treatment 2 exhibited higher root volumes compared to the untreated at 14 days.

All ethoxylated lecithin treatments exhibited greater root lengths at 7 days compared to the untreated. At 14 days, treatments 2 and 5 exhibited root lengths less than the control and the other treatments exhibited higher root lengths.

At 7 days, treatments 2-4 and 6 exhibited greater root areas than the untreated and treatments 1 and 5 had root areas similar to the untreated. At 14 days, all ethoxylated lecithin treatments but treatment 5 exhibited root areas greater than the untreated.

At 14 days, treatments 3 and 4 exhibited root tip numbers greater than the untreated whereas all other treatments showed root tip numbers similar to the untreated

At 7 days, treatments 2-5 exhibited numbers of root forks greater than the untreated and treatment 1 was similar to the untreated. At 14 days, treatments 3 and 4 exhibited numbers of root forks greater than the untreated and all other treatments were similar to the control.

All ethoxylated lecithin treatments exhibited greater numbers of root crossings than the control at 7 days after application. At 14 days, only treatment number 2 showed numbers of root crossings lower than the untreated.

Overall, the two alternative sources of ethoxylated lecithin performed similarly to commercial ethoxylated lecithin.

The application methods and rates of ethoxylated lecithin on root development were studied utilizing three rates for each of two applications methods, foliar spray and “in-vial” or root, in the mung bean bioassay protocol described above. The root morphology quantified after 7 and 14 days by WinRHIZO was compared between treatments.

### Treatments

| Treatment | Product | Rate (% v/v) | Application Type |
|---|---|---|---|
| 1 | Ethoxylated Lecithin | 0.0093 | Root |
| 2 | Ethoxylated Lecithin | 0.0187 | Root |
| 3 | Ethoxylated Lecithin | 0.0374 | Root |
| 4 | Untreated | 0 | |
| 5 | Ethoxylated Lecithin | 0.0093 | Foliar |
| 6 | Ethoxylated Lecithin | 0.0187 | Foliar |
| 7 | Ethoxylated Lecithin | 0.0374 | Foliar |
| 8 | Untreated | 0 | |

Root growth parameters (root length, area, volume, forks, and tips) were enhanced when ethoxylated lecithin was applied via “in-vial.” Ethoxylated lecithin when applied via foliar application had no effect on root growth. Visual observations indicated that foliar application of ethoxylated lecithin increased leaf size.

### Example 3

### In-Furrow Applications

The effect of in-furrow application of ethoxylated lecithin was investigated on radish germination and seedling growth. Radish seeds (variety Cherry Belle) were placed in plastic flats (11×21.5 in) three-quarters filled with Fertilome potting mix. Each tray contained two rows of seeds, with 11 seeds per row. Prior to covering the seeds with additional potting mix, treatments were topically applied to each seed using a pipet. The volume per seed was calculated using a seeding rate of 598,950 seeds/acre and an application volume of 5 gpa. Upon treatment, seeds covered with ¼-inch layer of potting mix. Trays were kept under artificial grow lights at 26° C. with a 13:11 h (L:D) photoperiod. Seedling germination was evaluated 4 days after planting, and study was terminated 7 days after germination. Plant height and above ground biomass were recorded at study termination.

### Treatments

| Treatment | Product | Rate (% v/v) |
|---|---|---|
| 1 | Untreated | 0 |
| 2 | Ethoxylated Lecithin | 0.0625 |
| 3 | Ethoxylated Lecithin | 1.25 |
| 4 | Ethoxylated Lecithin | 1.875 |
| 5 | Ethoxylated Lecithin | 100 |

Ethoxylated lecithin at the rate of 0.0625 and 1.875% v/v positively impacted seedling height and vegetative growth, as measured by fresh and dry biomass of radish seedlings. Visual observations indicated that ethoxylated enhanced the size of radish canopy. Crude ethoxylated lecithin (100% v/v) delayed seed germination and was detrimental to seedling development.

The effect of in-furrow application of ethoxylated lecithin was also investigated on radish vegetative development and yield. Three radish seeds (variety Cherry Belle, Jung's Seeds) were placed in a 2 L plastic pot filled with Fertilome potting mix with four replications per treatment. Prior to covering the seeds with additional potting mix, treatments were topically applied to each seed using a pipet. The volume per seed was calculated using a seeding rate of 598,950 seeds/acre and an application volume of 5 gpa. Upon treatment, seeds covered with ¼-inch layer of potting mix. The study was conducted under artificial grow lights at 26° C. with a 13:11 h L:D photoperiod. Plant height and canopy (Canopeo app) were evaluated at 7 and 14 days after planting. At 21 days after planting, radish tubers were harvested to determine weight, height, and diameter. Above ground biomass (fresh weight) was also recorded.

### Treatments

| Treatment | Product | Rate (% v/v) |
|---|---|---|
| 1 | Untreated | 0 |
| 2 | Ethoxylated Lecithin | 0.3125 |
| 3 | Ethoxylated Lecithin | 0.625 |
| 4 | Ethoxylated Lecithin | 1.25 |
| 5 | Ethoxylated Lecithin | 1.875 |

All rates of ethoxylated lecithin (0.313-1.875% v/v) increased seedling height relative to untreated treatment. All rates of ethoxylated lecithin (0.313-1.875% v/v) increased canopy size relative to untreated treatment. All rates of ethoxylated lecithin (0.313-1.875% v/v) enhanced tuber weight relative to untreated treatment. Tuber length remained similar to untreated plants whereas tuber diameter was enhanced by ethoxylated lecithin. Above ground biomass (fresh weight) was positively impacted by ethoxylated lecithin.

### Example 4

### Salinity Effects

The effect of ethoxylated lecithin on the vegetative growth of corn and soybean under high salinity irrigation water was investigated. One seed of each plant (soybean var Williams 82; corn Pioneer Hybrid adapted to Wisconsin) was grown in 1-liter pots filled with potting mix (Ultimate Potting Mix, Fertilome). Both soybean and corn plants were grown under artificial light 14:10 h L:D photoperiod at 23±4° C. Once corn and soybean reached the second vegetative stage (V2 soybean: second trifoliate fully expanded; V2 corn: two of the lowest leaves have a visible collar, the second and subsequent leaves have pointed tips), fertilizer was applied weekly with a customized NPK+ micronutrients mixture, whereas irrigation water containing the designated treatments was applied twice a week. During each irrigation event, each pot received approximately 500 ml of irrigation water with different levels of salinity, with or without ethoxylated lecithin. A total of 8 treatments with 4 replications were used for each plant species. Soybean height, canopy, fresh and dry weight was evaluated 31 days after treatment initiation. For corn plants, fresh and dry weight was evaluated at 16 days after treatment initiation.

| | Irrigation Water | |
|---|---|---|
| Treatment | NaCl (mM) | Ethoxylated Lecithin Rate (% v/v) |
| 1 | 0 | 0 |
| 2 | 80 | 0 |
| 3 | 120 | 0 |
| 4 | 180 | 0 |
| 5 | 0 | 0.0747 |
| 6 | 80 | 0.0747 |
| 7 | 120 | 0.0747 |
| 8 | 180 | 0.0747 |

Soybeans irrigated without NaCl but treated with ethoxylated lecithin had greater length, canopy, fresh and dry weight than untreated than plants without ethoxylated lecithin chemigation. At 80 mM of NaCl, soybean plants treated with ethoxylated lecithin had greater length, canopy, fresh and dry weight than plants without ethoxylated lecithin chemigation. At 80, 120, and 180 mM of NaCl, corn treated with ethoxylated lecithin had greater fresh and dry weight than plants without ethoxylated lecithin chemigation.

### Example 5

### Root Development in Hydroponics

The effects of ethoxylated lecithin (VITEX) tank mixed with commercial biostimulants, Potente (Sipcam Agro, Durham, NC), Baccarat (Sipcam Agro, Durham, NC), NuTex (Sipcam Agro, Durham, NC), and Toggle (Acadian Plant Health, Nova Scotia, Canada) were evaluated utilizing a mungbean bioassay and the WinRHIZO root scanning system. The mung bean bioassay was designed to compare root development as a result of hydroponically treating mung bean shoots. The mung bean shoots were sampled and analyzed after 7 and 14 days. The mung bean bioassay protocol is as follows:

SEED GERMINATION Fertilome Professional potting mix was used to grow mung bean plants. The mix contained sphagnum peat moss, coarse perlite, dolomitic limestone, calcitic limestone, starter nutrient charge and a wetting agent. The mixes were mixed with deionized water and added into a seed tray. A 200 cell plug tray was used to evenly plant mung bean seeds. The seeds were covered with about 1.5 L of the soil mixture and watered in with 600 mL of distilled water. Trays were kept inside a growth chamber at 25° C. with a 13:11 h Light:Dark photoperiod.

SEEDLING TRANSFER The studies were initiated when seedlings were at VC stage (unifoliate fully expanded; −5-7 days after seeding). Seedlings were cut off at soil level and cotyledons carefully removed by twisting off in an upward pulling motion. Using a ruler or marked cutting board, the hypocotyls were cut exactly 4 cm below the cotyledons using a razor-sharp scalpel blade. Seedlings were placed in 20 ml scintillation vials containing 12 ml of the treatment solution and maintained inside a growth chamber for the duration of the study.

ROOT SCAN MEASUREMENT A WinRHIZO root scanner was used to scan the roots after one week of growth (see WinRHIZO root scanner manual). The plants were cut to the top root from the bottom of the stem and all 10 plants from each treatment were scanned together. Root Length, Surface Area, Volume and Average Diameter were graphed to compare each treatment along with the controls.

### Treatments

| | | | Rate 1 | Rate 2 |
|---|---|---|---|---|
| Treatment | Product 1 | Product 2 | (% v/v) | (% v/v) |
| 1 | Potente | — | 0.06 | 0 |
| 2 | Potente | Ethoxylated lecithin | 0.06 | 0.0747 |
| 3 | Baccarat | — | 0.06 | 0 |
| 4 | Baccarat | Ethoxylated lecithin | 0.06 | 0.0747 |
| 5 | NuTex | — | 0.0625 | 0 |
| 6 | NuTex | Ethoxylated lecithin | 0.0625 | 0.0747 |
| 7 | Toggle | — | 0.6 | 0 |
| 8 | Toggle | Ethoxylated lecithin | 0.6 | 0.0747 |
| 9 | Ethoxylated | — | 0.0747 | — |
| | lecithin | | | |

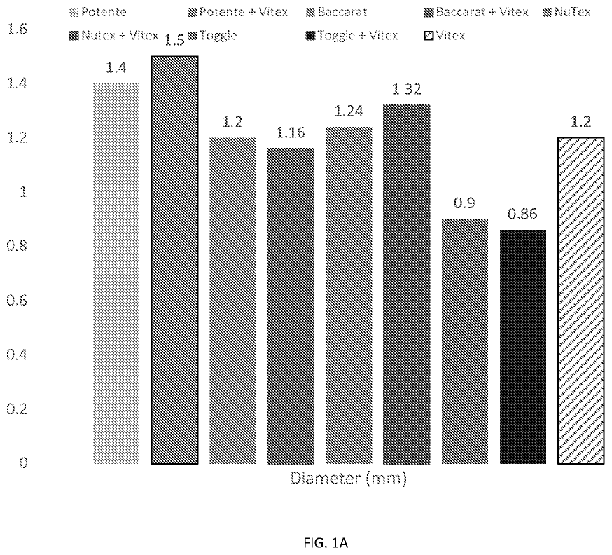

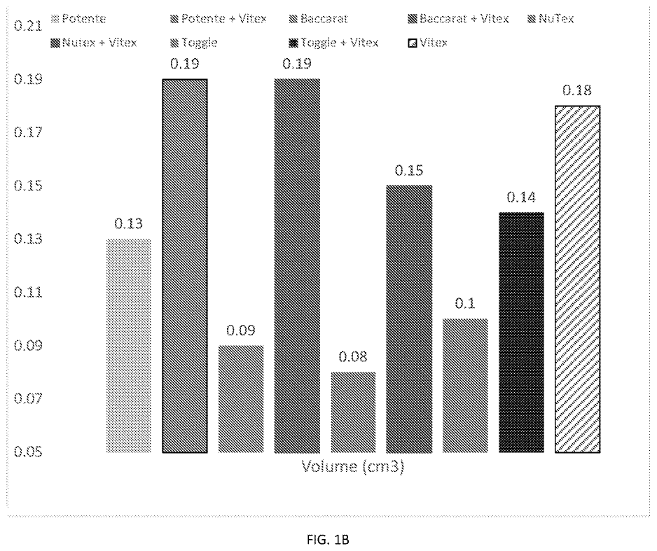

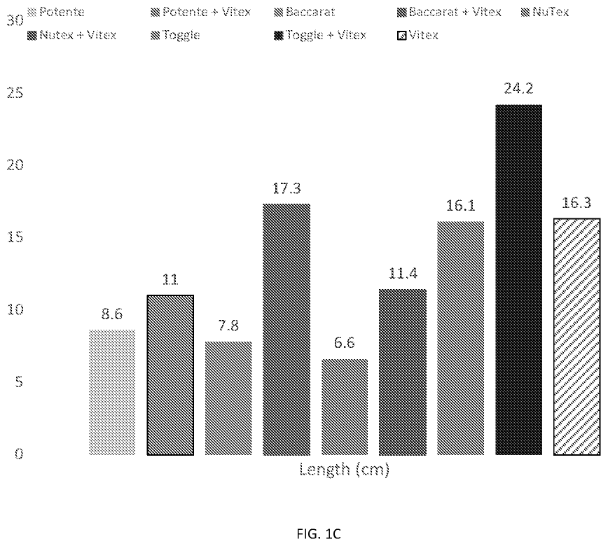

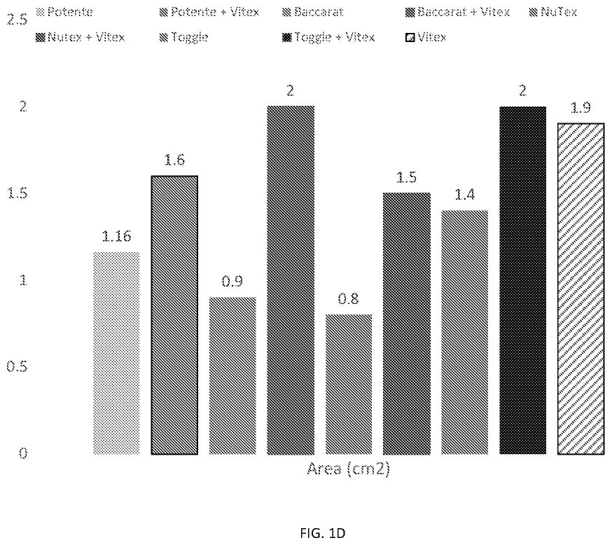

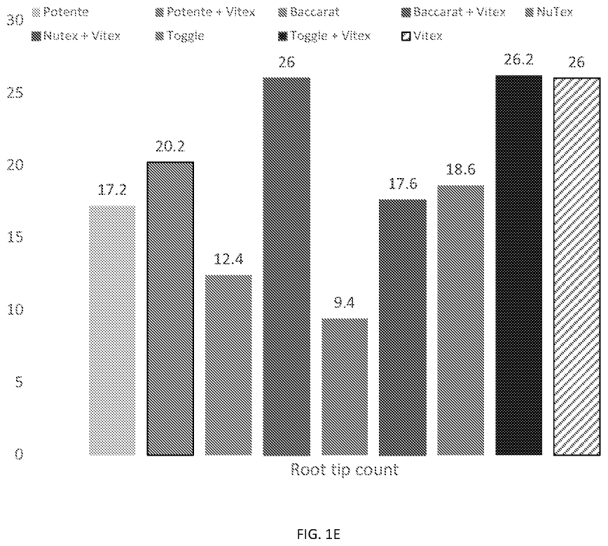

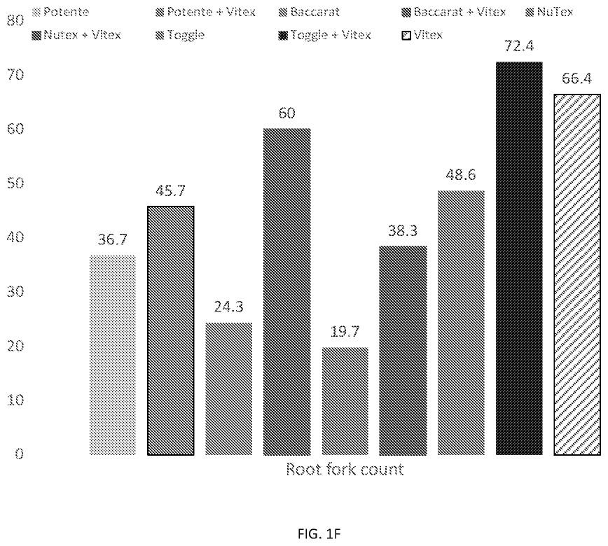

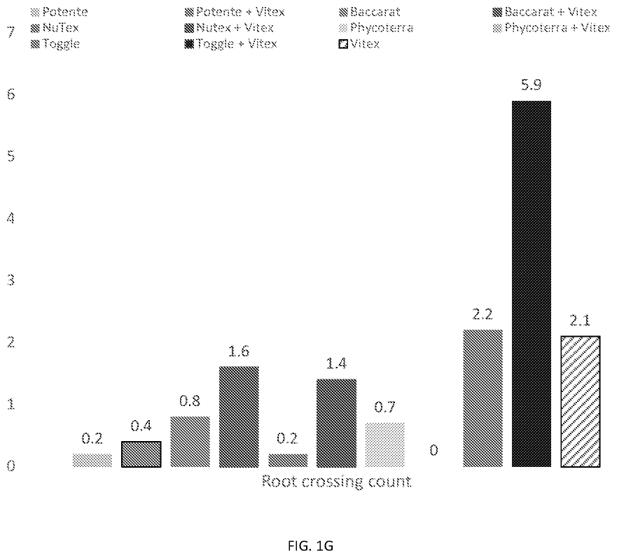

At 7 days, the commercial biostimulants tested, Potente, Baccarat, NuTex and Toggle, exhibited improved root parameters when tank-mixed with ethoxylated lecithin (FIGS. 1A-1G, Tables 1 and 2). The observed relative increase (percentage) for root parameters were as follows: 32-111.43 for root area, 17.05-121.71 for root length, 35.63-100.86 for root volume, 17.44-111.29 for number of root tips, 3.15-146.77 for number of root forks and 50-200 for number of root crossings.

At 14 days, the commercial biostimulants tested, Potente, Baccarat, NuTex and Toggle, exhibited improved root parameters when tank-mixed with ethoxylated lecithin. The observed relative increase (percentage) for root parameters were as follows: 33.83-93.65 for root area, 38.38-131.79 for root length, 29.30-95.72 for root volume, 12.31-98.97 for number of root tips, 18.71-128.49 for number of root forks and 22.22-800 for number of root crossings (Table 3).

TABLE 1
Mung bean root parameters at 7 days after study initiation. Lower case letters
indicate statistically significant differences at the alpha = 0.05 level.

| | Length | | Area | | Diameter | | Volume | | | | | | | |
|---|---|---|---|---|---|---|---|---|---|---|---|---|---|---|
| Treatment | (cm) | | (cm2) | | (mm) | | (cm3) | | Tips | | Forks | | Crossings | |
| Potente | 8.6 | c | 1.2 | bcd | 1.4 | ab | 0.1 | b-e | 17.2 | ab | 36.7 | abc | 0.2 | b |
| Potente + | 11.0 | bc | 1.6 | ab | 1.5 | a | 0.2 | a | 20.2 | ab | 45.7 | abc | 0.4 | b |
| Ethoxylated | | | | | | | | | | | | | | |
| lecithin | | | | | | | | | | | | | | |
| Baccarat | 7.8 | c | 1.0 | cd | 1.2 | bc | 0.1 | de | 12.4 | b | 24.3 | bc | 0.8 | b |
| Baccarat + | 17.3 | b | 2.0 | a | 1.2 | c | 0.2 | ab | 26.2 | a | 60.0 | ab | 1.6 | ab |
| Ethoxylated | | | | | | | | | | | | | | |
| Lecithin | | | | | | | | | | | | | | |
| NuTex | 6.6 | c | 0.8 | d | 1.2 | bc | 0.1 | e | 9.4 | b | 19.7 | c | 0.2 | b |
| NuTex + | 11.4 | bc | 1.5 | abc | 1.3 | abc | 0.2 | abc | 17.6 | ab | 38.3 | abc | 1.4 | ab |
| Ethoxylated | | | | | | | | | | | | | | |
| lecithin | | | | | | | | | | | | | | |
| Toggle | 16.1 | b | 1.4 | abc | 0.9 | d | 0.1 | cde | 18.6 | ab | 48.6 | abc | 2.2 | ab |
| Toggle + | 24.2 | a | 2.1 | a | 0.9 | d | 0.1 | a-d | 26.2 | a | 72.4 | a | 5.9 | a |
| Ethoxylated | | | | | | | | | | | | | | |
| lecithin | | | | | | | | | | | | | | |
| Ethoxylated | 16.5 | | 1.9 | | 1.2 | | 0.2 | | 26.6 | | 66.8 | | 2.6 | |
| lecithin* | | | | | | | | | | | | | | |

TABLE 2
Mung bean root parameters at 14 days after study initiation. Lower case letters
indicate statistically significant differences at the alpha = 0.05 level.

| | Length | | Area | | Diameter | | Volume | | | | | | | |
|---|---|---|---|---|---|---|---|---|---|---|---|---|---|---|
| Treatment | (cm) | | (cm2) | | (mm) | | (cm3) | | Tips | | Forks | | Crossings | |
| Potente | 9.5 | f | 1.3 | d | 1.4 | a | 0.1 | c | 20.3 | d | 36.9 | d | 0.0 | d |
| Potente + | 15.3 | ef | 2.3 | c | 1.5 | a | 0.3 | a | 31.9 | c | 78.6 | bc | 1.3 | cd |
| Ethoxylated | | | | | | | | | | | | | | |
| lecithin | | | | | | | | | | | | | | |
| Baccarat | 31.6 | c | 2.4 | c | 0.8 | d | 0.1 | c | 46.3 | ab | 120.5 | b | 8.9 | b |
| Baccarat + | 17.3 | de | 1.7 | c | 1.0 | bc | 0.1 | c | 27.1 | cd | 55.5 | cd | 1.2 | cd |
| Ethoxylated | | | | | | | | | | | | | | |
| Lecithin | | | | | | | | | | | | | | |
| NuTex | 9.8 | f | 1.1 | d | 1.1 | b | 0.1 | d | 19.0 | d | 36.7 | d | 0.6 | cd |
| NuTex + | 22.9 | d | 2.1 | c | 0.9 | c | 0.2 | c | 38.2 | bc | 84.4 | bc | 5.0 | bc |
| Ethoxylated | | | | | | | | | | | | | | |
| lecithin | | | | | | | | | | | | | | |
| Toggle | 48.0 | b | 3.0 | b | 0.6 | e | 0.2 | c | 50.0 | ab | 196.2 | a | 26.5 | a |
| Toggle + | 67.2 | a | 4.1 | a | 0.6 | e | 0.2 | b | 57.9 | a | 235.0 | a | 32.8 | a |
| Ethoxylated | | | | | | | | | | | | | | |
| lecithin | | | | | | | | | | | | | | |
| Ethoxylated | 18.39 | | 2.13 | | 1.17 | | 0.20 | | 34.0 | | 74.6 | | 3.2 | |
| lecithin* | | | | | | | | | | | | | | |

TABLE 3
Relative change (percentage) in root growth parameters in tank-mixes
ethoxylated lecithin compared to commercial biostimulants alone.

| | Potente + | | Baccarat + | | NuTex + | | Toggle + | |
|---|---|---|---|---|---|---|---|---|
| | Ethoxylated | | Ethoxylated | | Ethoxylated | | Ethoxylated | |
| Root | lecithin | | lecithin | | lecithin | | lecithin | |
| Parameter | 7 DA-A | 14 DA-A | 7 DA-A | 14 DA-A | 7 DA-A | 14 DA-A | 7 DA-A | 14 DA-A |
| Length | 17.05 | 59.89 | 121.71 | −45.69 | 75.04 | 131.79 | 49.07 | 38.38 |
| Area | 32.04 | 73.17 | 111.43 | −27.07 | 85.61 | 93.65 | 43.17 | 33.83 |
| Volume | 47.05 | 87.37 | 100.86 | −2.07 | 95.72 | 61.67 | 35.63 | 29.30 |
| Tips | 17.44 | 54.81 | 111.29 | −41.18 | 87.23 | 98.97 | 40.86 | 12.31 |
| Forks | 3.15 | 108.47 | 146.77 | −53.28 | 96.97 | 128.49 | 40.61 | 18.71 |
| Crossings | 50.00 | 800.00 | 57.14 | −84.00 | 200.00 | 460.00 | 128.57 | 22.22 |

### Example 6

### Iron Uptake Improvement in Soybeans

The effect of ethoxylated lecithin (VITEX) in the uptake of chelated iron (Soygreen AST, CHS Agronomy) in soybeans was evaluated by an in-furrow application. The study was conducted using 1-gallon pots filled with pre-washed sand (growing media), where one soybean seed (variety Williams 82) was placed in center of each pot. Prior to covering the seeds with additional sand, treatments were topically applied to each seed using a pipet. The volume per seed was calculated using a seeding rate of 140,000 seeds per acre and an application volume of 5 gpa. Upon, treatment seeds were covered with ¼ inch layer of sand. Plants were kept under artificial grow lights at 25° C. with a 13:11 h (L:D) photoperiod and regularly fertilized using a customized Hogland's solution omitting iron. When soybeans were at V5 stage (fifth trifoliate fully extended), plant tissue was collected by cutting the youngest fully developed trifoliate. Soybean tissue of known weight was dried and digested with hydrochloric acid prior to measuring iron content using the phenantroline method in a spectrophotometer (Epoch 2, Agilent Biotek).

### Treatments

| Treatment | Product | Rate 1 | | Rate 2 |
|---|---|---|---|---|
| 1 | Untreated (negative control) | — | | — |
| 2 | Untreated (positive control) - Ethoxylated | 0.0747% | v/v | — |
| | lecithin | | | |
| 3 | Soygreen AST | 0.25 | qt/a | — |
| 4 | Soygreen AST | 0.625 | qt/a | — |
| 5 | Soygreen AST | 1.56 | qt/a | — |
| 6 | Soygreen AST | 3.90 | qt/a | — |
| 7 | Soygreen AST + Ethoxylated lecithin | 0.25 | qt/a | 0.0747% v/v |
| 8 | Soygreen AST + Ethoxylated lecithin | 0.625 | qt/a | 0.0747% v/v |
| 9 | Soygreen AST + Ethoxylated lecithin | 1.56 | qt/a | 0.0747% v/v |
| 10 | Soygreen AST + Ethoxylated lecithin | 3.90 | qt/a | 0.0747% v/v |

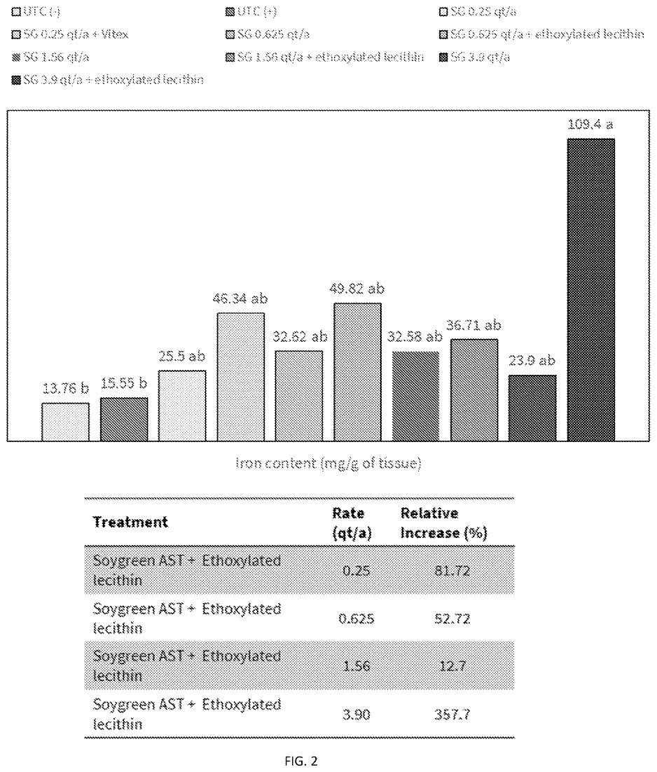

Ethoxylated lecithin improved iron uptake relative in Soygreen AST treatments (FIG. 2). For lower use rates (0.25 to 0.625 qt/a), soybean tissue had on average 67.22% more iron per gram of tissue than soybean treated without ethoxylated lecithin. For higher use rates (1.56-3.9 qt/a), the increase was on average 185% more iron per gram of issue in soybean treated with ethoxylated lecithin.

### Example 7

### Water Use Efficiency in Hydroponic Tomatoes

Cherry tomato seeds (variety SunSugar Hybrid, Jung Seeds) were germinated in rock wool blocks (one seed per block). Rock wool blocks were placed inside a 40 cell plug tray previously filled with 200 ml deionized water. Plants were kept under artificial grow lights at 25° C. with a 13:11 h (L:D) photoperiod and equally fertilized with a starter fertilizer.

The study was initiated when seedlings were at V3 stage (3 true leaves unrolled). At that stage, 4 tomato seedlings were transferred into a customized hydroponic containing the designated treatment (one box per treatment) of fertilizer or fertilizer with ethoxylated lecithin (VITEX) as shown below. Hydroponic boxes were built with a 15 L plastic container covered with pre-drilled plastic lid to fit 4 plastic cups, where seedlings were placed. An aquarium pump was placed in each box to ensure continuous oxygen supply throughout the study. Treatments were applied to each hydroponic system, previously filled with 18 L of deionized water. The fertilizer rate designated as 0.5× delivered the following nutrients: 105.0 ppm N, 31.0 ppm P, 136.8 ppm K, 11.0 ppm Na, 100.0 ppm Ca, 24.0 ppm Mg, 32.0 ppm S, 17.7 ppm Cl, 2.5 ppm Fe, 0.25 ppm B, 0.25 ppm Mn, 0.02 ppm Zn, 0.01 ppm Cu, and 0.005 ppm Mo. The 1× fertilizer treatment was twice as concentrated as the mix described above, and the 2× fertilizer treatment was four times as concentrated as the mix above.

At 10 days after treatment application, canopy (percent cover) was assessed using Canopeo App. Study was concluded at 21 days after treatment application, when plant height, canopy, fresh aerial biomass, dry aerial and root biomass, water use efficiency (e.g., quantity of water to generate one unit of biomass) and root parameters (root length, surface area, volume, and average diameter) were measured. Results were graphed to compare each treatment along with the controls. For root measurements, the WinRHIZO root scanner was used to scan each root system (see WinRHIZO root scanner manual).

### Treatments

| Treatment | Product | Rate (% v/v) |
|---|---|---|
| 1 | ½x Fertilizer | 0 |
| 2 | 1x Fertilizer | 0 |
| 3 | 2x Fertilizer | 0 |
| 4 | ½x Fertilizer + Ethoxylated lecithin | 0.018675 |
| 5 | 1x Fertilizer + Ethoxylated lecithin | 0.018675 |
| 6 | 2x Fertilizer + Ethoxylated lecithin | 0.018675 |

Ethoxylated lecithin increased cherry tomato canopy size at 10 and 21 days after treatment application (Table 4). At 21 days after application, cherry tomato height and canopy were improved by ethoxylated lecithin, with the greatest impact at 1× fertilizer rate (Tables 4 and 5). At 21 days after application, cherry tomato fresh and dry biomass was improved by ethoxylated lecithin at 1× and 2× fertilizer rate (Table 5).

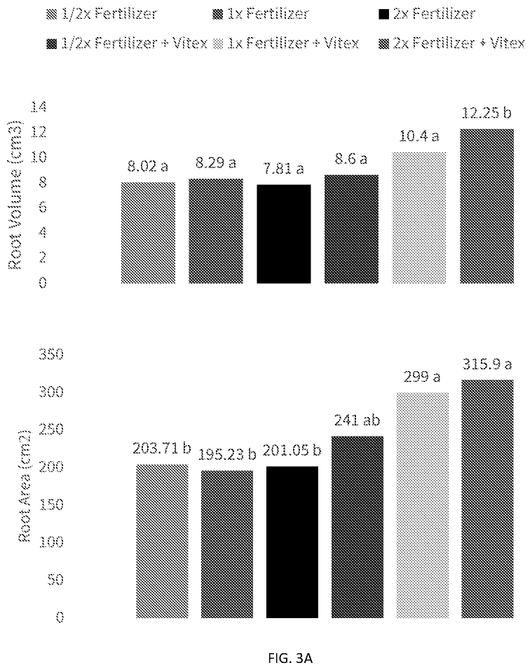

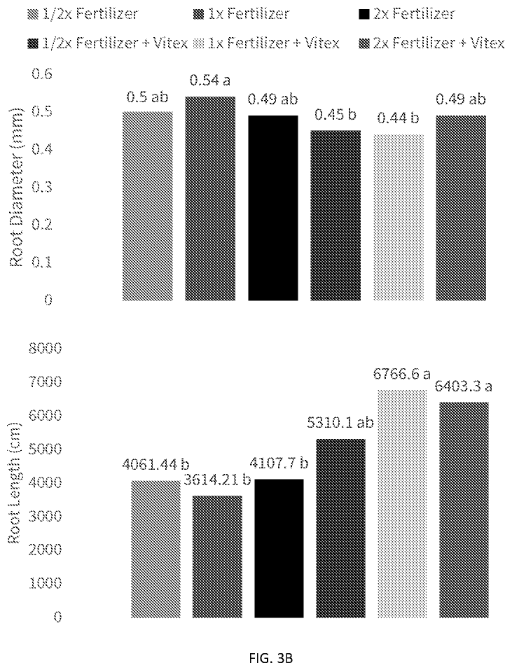

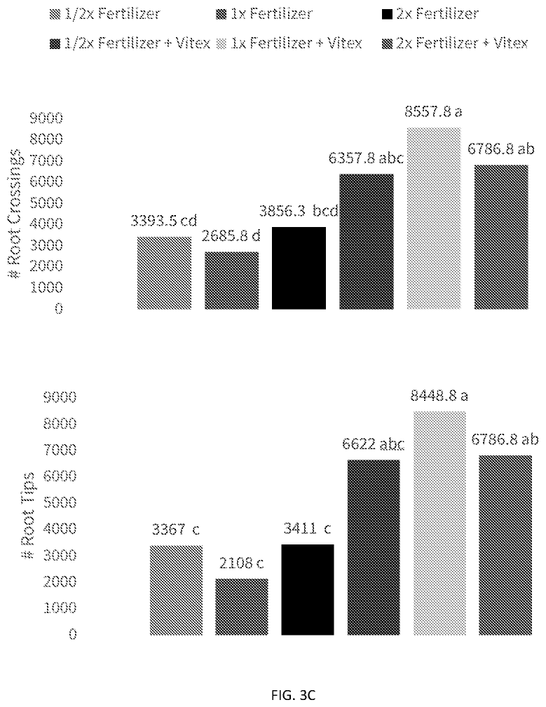

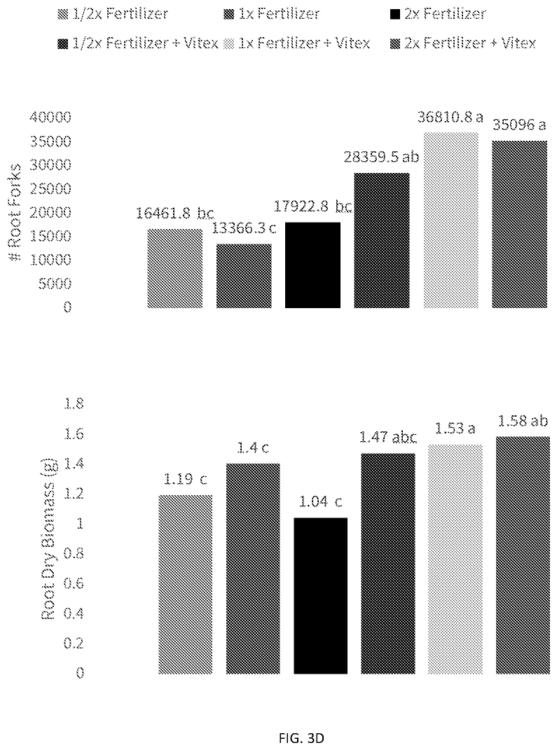

Ethoxylated lecithin applied in conjunction to different rates of fertilizer increased root dry biomass and root morphological parameters (FIGS. 3A-3D: root volume, root area, root length, root tips count, root crossing count and root fork count).

Ethoxylated lecithin applied in conjunction to 1× and 2× fertilizer rates improved water use efficiency compared to 1× fertilizer rate alone (Table 6).

TABLE 4
Cherry tomato canopy (% cover) at 10 and 21 days after application
of ethoxylated lecithin and relative (fertilizer treatment
without ethoxylated lecithin) growth increase at 21 days after
application. Lower case letters indicate statistically significant
differences at the alpha = 0.05 level.

| | | | Relative |
|---|---|---|---|
| | Canopy (%) | Canopy (%) | Increase (%) - |
| Treatment | (20 DA-A) | (31 DA-A) | 31 DA-A |
| ½x Fertilizer | 5.463 | 12.05 b | 54.83 ab |
| 1x Fertilizer | 5.963 | 12.71 b | 51.79 ab |
| 2x Fertilizer | 5.123 | 14.1 b | 63.89 ab |
| ½x Fertilizer + | 6.62 | 12.16 b | 43.78 b |
| Ethoxylated lecithin | | | |
| 1x Fertilizer + | 6.70 | 15.31 ab | 55.79 ab |
| Ethoxylated lecithin | | | |
| 2x Fertilizer + | 5.48 | 17.98 a | 69.18 a |
| Ethoxylated lecithin | | | |
| LSD | 1.49 | 2.87 | 15.54 |
| P | 0.18 | 0.0028 | 0.04 |

TABLE 5
Cherry tomato fresh and dry biomass (aerial parts) and
plant height at 21 days after application of ethoxylated
lecithin. Lower case letters indicate statistically significant
differences at the alpha = 0.05 level.

| | Fresh | Dry | Plant |
|---|---|---|---|
| Treatment | biomass (g) | biomass (g) | Height (cm) |
| ½x Fertilizer | 66.7 b | 7.01 | 30.7 |
| 1x Fertilizer | 71.02 b | 7.15 | 29.1 |
| 2x Fertilizer | 62.66 b | 5.61 | 27.3 |
| ½x Fertilizer + | 64.65 b | 7.33 | 28.2 |
| Ethoxylated lecithin | | | |
| 1x Fertilizer + | 88.37 a | 8.89 | 32.5 |
| Ethoxylated lecithin | | | |
| 2x Fertilizer + | 96.46 a | 8.26 | 27.9 |
| Ethoxylated lecithin | | | |
| LSD | 23.33 | 2.51 | 5.51 |
| P | 0.031 | 0.17 | 0.38 |

TABLE 6
Cherry tomato water use efficiency (WUF) in grams
per liter at 31 days after study initiation.

| | Cumulative | | |
|---|---|---|---|
| Treatment | Water Use (ml) | Dry biomass (g) | WUF (g per L) |
| ½x Fertilizer | 20000 | 7.01 | 0.35 |
| 1x Fertilizer | 21060 | 7.15 | 0.33 |
| 2x Fertilizer | 22850 | 5.61 | 0.24 |
| ½x Fertilizer + | 22100 | 7.33 | 0.33 |
| Ethoxylated lecithin | | | |
| 1x Fertilizer + | 21250 | 8.89 | 0.42 |
| Ethoxylated lecithin | | | |
| 2x Fertilizer + | 21810 | 8.26 | 0.37 |
| Ethoxylated lecithin | | | |

### Example 8

### Turf Biomass and Quality Improvement

To evaluate the effect of ethoxylated lecithin (VITEX) on bentgrass biomass and quality in a putting green setting, a study was designed as a randomized complete block design with four replications. Individual plots measured 6×4 feet. The study site was on a bentgrass putting green constructed according to USGA recommendations and mowed at 0.125 inches five days a week. The putting green was maintained similarly to a high-end putting green in the Midwest. The treatments were applied using a CO₂-powered backpack sprayer calibrated to deliver 86 gallons per acre. Data collected for the study included dry clipping mass, visual turfgrass quality, and normalized difference red edge (NDRE) index. Clippings were collected twice per week, with visual quality and NDRE values collected weekly for six weeks after application. After collection, clippings were cleaned of sand and other debris using the water floatation method, dried at 140° F. for a minimum of 72 hours, and massed. Turfgrass visual quality was assessed using the 1-9 scale, with 9 being an optimal turf cover and 6 being a minimally acceptable turf under golf course conditions. NDRE was measured using a Holland Scientific CS-45 meter (Lincoln, NE). Treatment means were separated using Fisher's Least Significant Difference at alpha=0.05.

### Treatments

| Treatment | Product | Rate (% v/v) | Application Date |
|---|---|---|---|
| 1 | Untreated | n/a | n/a |
| 2 | Ethoxylated lecithin | 0.075 | June 2 |

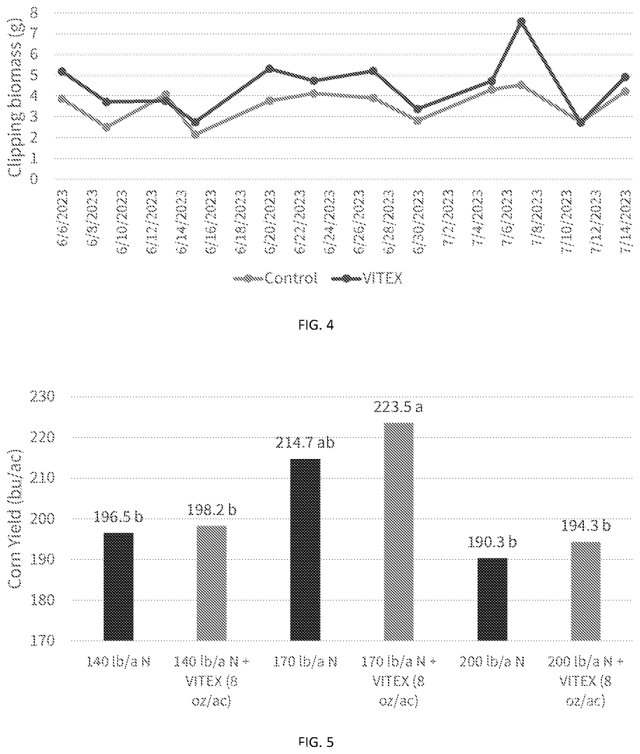

Ethoxylated lecithin increased clipping biomass throughout the study evaluations (June 6 to July 14) (Table 7 and FIG. 4). Ethoxylated lecithin improved turf visual quality (1-9 scale) over time (Table 8). Ethoxylated lecithin improved normalized difference red edge (NDRE) index over time (Table 9).

TABLE 7
Clipping mass at each measurement date during the study.

| | 6- | 9- | 13- | 15- | 20- | 23- | 27- | 30- | 5- | 7- | 11- | 14- |
|---|---|---|---|---|---|---|---|---|---|---|---|---|
| Treatment | Jun | Jun | Jun | Jun | Jun | Jun | Jun | Jun | Jul | Jul | Jul | Jul |
| | g m⁻² | | | | | | | | | | | |
| Untreated | 3.87 | 2.49 | 4.06 | 2.14 | 3.76 | 4.12 | 3.9 | 2.8 | 4.31 | 4.53 | 2.74 | 4.21 |
| Ethoxylated | 5.18 | 3.71 | 3.76 | 2.74 | 5.31 | 4.73 | 5.21 | 3.37 | 4.72 | 4.58 | 2.71 | 4.91 |
| lecithin | | | | | | | | | | | | |

TABLE 8
Visual estimate of turfgrass quality at each rating date during the study.

| Treatment | 9-Jun | 15-Jun | 23-Jun | 30-Jun | 7-Jul | 14-Jul |
|---|---|---|---|---|---|---|
| | -------------------------------------- 1-9, 9 is best ----------------------------------- | | | | | |
| Untreated | 7 | 6.8 | 6.5 | 6 | 5.8 | 6.3 |
| Ethoxylated lecithin | 6.8 | 7 | 6.8 | 6.8 | 6.8 | 6.3 |

TABLE 9
NDRE at each rating date during the study.

| Treatment | 9-Jun | 15-Jun | 23-Jun | 30-Jun | 7-Jul | 14-Jul |
|---|---|---|---|---|---|---|
| Untreated | 0.269 | 0.251 | 0.277 | 0.28 | 0.292 | 0.275 |
| Ethoxylated | 0.27 | 0.264 | 0.286 | 0.291 | 0.294 | 0.295 |
| lecithin | | | | | | |

### Example 9

### Corn N Assimilation Improvement

The study was performed to evaluate the effect of ethoxylated lecithin (VITEX) in sidedress applications of N in corn. A field study in silt loam soil (35% sand, 42% silt, 23% clay and 2.4% organic matter) planted with corn (hybrid Becks 4421Q) at a seeding rate of 35400 seeds per acre. The study was a randomized complete block design with six replications per treatment. Individual plot (replicated) measured 10×40 ft with 30″ row spacing. Nitrogen in-furrow applications (at planting) were performed according to local agronomic practices, at a carrier volume of 5 gpa using urea ammonium nitrate (UAN) (28-0-0) as the N source. Treatment applications (e.g., ethoxylated lecithin) were applied via injection whereas sidedress N were applied simultaneously with the sidedresser at the V6 stage (34 days after emergence). At maturity, a 5 ft×40 ft area was harvested in each plot and grain yield was adjusted to 12% moisture.

### Treatments

| | | | Rate 1 | Rate 2 |
|---|---|---|---|---|
| Treatment | Product 1 | Product 2 | (lb N/a) | (fl oz/a) |
| 1 | UAN | — | 140 | |
| 2 | UAN | — | 170 | |
| 3 | UAN | — | 200 | |
| 4 | UAN | Ethoxylated lecithin | 140 | 8 |
| 5 | UAN | Ethoxylated lecithin | 170 | 8 |
| 6 | UAN | Ethoxylated lecithin | 200 | 8 |

Ethoxylated lecithin improved corn yield at each nitrogen rate compared to treatments not receiving ethoxylated lecithin (FIG. 5).

### Example 10

### Fertigation Application in Romaine Lettuce

Lettuce was grown in pots with greenhouse potting mix. Different rates of ethoxylated lecithin (VITEX) were applied to the soil in combination with fertilizer in a sequence of 4 applications, designed as A, B, C and D. Application A was performed after seedling emergence, and applications B, C and D occurred in an interval of 15 days after application A. Canopy coverage was evaluated using digital image analysis, and select replicates of the study were destructively analyzed at three time points for foliar biomass measurement. Root characteristics were analyzed using WinRhizo on plants harvested 42 days after the first application.

| | | Appli- | Appli- | Appli- | Appli- |
|---|---|---|---|---|---|
| | | cation | cation | cation | cation |
| Treat- | | A rate | B rate | C rate | D rate |
| ment | Product | (fl oz/a) | (fl oz/a) | (fl oz/a) | (fl oz/a) |
| 1 | — | | | | |
| 2 | Ethoxylated | 2 | 2 | 2 | 2 |
| | lecithin | | | | |
| 3 | Ethoxylated | 4 | 4 | 4 | 4 |
| | lecithin | | | | |
| 4 | Ethoxylated | 8 | 8 | 8 | 8 |
| | lecithin | | | | |
| 5 | Ethoxylated | 16 | 16 | 16 | 16 |
| | lecithin | | | | |
| 6 | Ethoxylated | 32 | 32 | 32 | 32 |
| | lecithin | | | | |
| 7 | Ethoxylated | 64 | 64 | 64 | 64 |
| | lecithin | | | | |
| 8 | Ethoxylated | 2 | 4 | 8 | 16 |
| | lecithin | | | | |
| 9 | Ethoxylated | 4 | 8 | 16 | 32 |
| | lecithin | | | | |

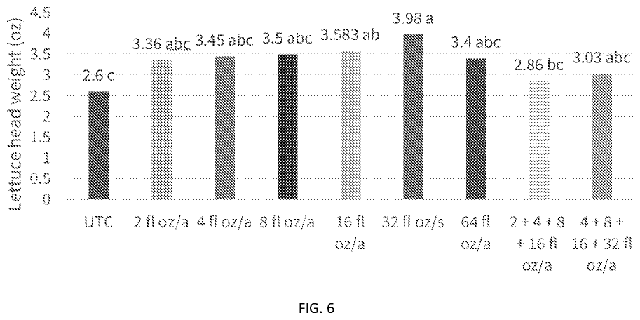

Ethoxylated lecithin treatments resulted in greater canopy coverage, biomass, with the greatest differences occurring 40-60 days after the first application (Table 10). These treatments also significantly increased lettuce yield over an untreated control (UTC), as measured by head weight (FIG. 6).

TABLE 10
Lettuce yield after indicated days following ethoxylated lecithin application. Lower
case letters indicate statistically significant differences at the alpha = 0.05 level.

| | | Application | Canopy | | Canopy | Canopy | | Canopy | |
|---|---|---|---|---|---|---|---|---|---|
| | Appli- | Rates | (%) | | (%) | (%) | | (%) | |
| Treatment | cations | (fl oz/a) | 47 DAA | | 51 DAA | 55 DAA | | 61 DAA | |
| Untreated | — | — | 38.066 | b | 37.328 | 44.458 | bc | 45.256 | b |
| Ethoxylated | ABCD | 2 + 2 + 2 + 2 | 40.969 | ab | 42.829 | 50.563 | abc | 52.219 | ab |
| lecithin | | | | | | | | | |
| Ethoxylated | ABCD | 4 + 4 + 4 + 4 | 45.068 | ab | 48.114 | 54.531 | a | 55.434 | ab |
| lecithin | | | | | | | | | |
| Ethoxylated | ABCD | 8 + 8 + 8 + 8 | 40.927 | ab | 39.253 | 51.053 | abc | 53.058 | ab |
| lecithin | | | | | | | | | |
| Ethoxylated | ABCD | 16 + 16 + 16 + | 47.936 | a | 46.515 | 54.99 | a | 58.13 | a |
| lecithin | | 16 | | | | | | | |
| Ethoxylated | ABCD | 32 + 32 + 32 + | 48.121 | a | 47.567 | 53.81 | ab | 59.358 | a |
| lecithin | | 32 | | | | | | | |
| Ethoxylated | ABCD | 64 + 64 + 64 + | 41.065 | ab | 43.69 | 51.943 | ab | 56.253 | ab |
| lecithin | | 64 | | | | | | | |
| Ethoxylated | ABCD | 2 + 4 + 8 + 16 + | 38.671 | ab | 39.895 | 42.066 | c | 47.313 | b |
| lecithin | | 32 | | | | | | | |
| Ethoxylated | ABCD | 4 + 8 + 16 + 32 | 39.181 | ab | 41.938 | 49.842 | abc | 50.71 | ab |
| lecithin | | | | | | | | | |

Ethoxylated lecithin treatments improved root length, root area, number of root tips, number of root forks, and number of root crossings across a range of application rates. The most effective rate varied by measurement, but the treatments receiving 16 and 32 fl oz/ac of ethoxylated lecithin across all four applications performed most consistently.

### Example 11

### Seed Treatment

Soybean seeds (Williams 82) were treated with varying rates of ethoxylated lecithin (VITEX) to determine the effect on seed germination rate and seedling biomass. Fifteen seeds per treatment were added into a flask with varying amounts of water+Ethoxylated lecithin, and treatments 1-7 were primed for 1 hour on a shaker with the treatment solutions. Treatment 8 used pure ethoxylated lecithin with no added water, and reacted with seeds for 5 minutes total to simulate a more traditional seed treatment application. Seeds were then dried at 30 C, planted in greenhouse potting soil, and maintained in a growth room at 25° C. with a 16:8 h L:D photoperiod at 70-80% relative humidity. Fourteen days after treatment, the germinated seedlings were harvested and weighed.

| | | | | Seedling Biomass |
|---|---|---|---|---|
| TRT | Product | Rate (% v/v) | % Germination | (wet weight g) |
| 1 | Water | 0 | 40% | 0.86 |
| 2 | Ethoxylated | 1.05 | 60% | 1.09 |
| | lecithin | | | |
| 3 | Ethoxylated | 3.125 | 60% | 0.96 |
| | lecithin | | | |
| 4 | Ethoxylated | 6.25 | 80% | 0.90 |
| | lecithin | | | |
| 5 | Ethoxylated | 12.5 | 73% | 0.88 |
| | lecithin | | | |
| 6 | Ethoxylated | 25 | 87% | 1.02 |
| | lecithin | | | |
| 7 | Ethoxylated | 50 | 93% | 0.86 |
| | lecithin | | | |
| 8 | Ethoxylated | 100 | 60% | 1.01 |
| | lecithin | | | |

Ethoxylated lecithin improved percent germination and seedling weight at all use-rates tested. There was a trend towards greater percent germination with increasing ethoxylated lecithin concentration in the priming treatments (1-7).

It is understood that the foregoing detailed description and accompanying examples are merely illustrative and are not to be taken as limitations upon the scope of the disclosure, which is defined solely by the appended claims and their equivalents.

Various changes and modifications to the disclosed embodiments will be apparent to those skilled in the art and may be made without departing from the spirit and scope thereof.

What is claimed is:

1. A method for improving plant growth or promoting plant health, comprising applying to a seed, or a plant, a plant part, a propagation material of the plant in an early stage of plant growth, or plant growth medium an effective amount of ethoxylated lecithin or a composition comprising thereof.

2. The method of claim 1, wherein the propagation material is a root, a corm, a tuber, a bulb, a slip, a cutting of the plant, or a rhizome.

3. The method of claim 1 or claim 2, wherein the early stage of plant growth comprises the seed stage, germination stage, seedling stage, and vegetative stage.

4. The method of any of claims 1-3, wherein the applying comprises seed spraying, seed dripping, seed dipping, seed coating, or hydroseeding.

5. The method of any of claims 1-4, wherein the applying comprises irrigating, drenching, spraying, in-furrow application, or direct incorporation into plant growth media.

6. The method of any of claims 1-5, wherein the plant growth medium is a soil-based growth medium, a hydroponic growth medium, an aquaponic growth medium, or an aeroponic growth medium.

7. A method comprising applying an effective amount of ethoxylated lecithin, or a composition thereof, to a plant seed or a plant propagation material.

8. The method of claim 7, wherein the method increases germination rate, enhances plant health, improves plant growth, and/or improves plant stress resistance in comparison to a plant grown from a seed or plant propagation material not treated with ethoxylated lecithin, or composition thereof.

9. The method of claim 7 or 8, wherein the applying comprises seed spraying, seed dripping, seed dipping, seed coating, or hydroseeding.

10. The method of any of claims 7-9, wherein the method further comprises one or both of: drying the seed and storing the seed comprising the ethoxylated lecithin or composition thereof.

11. The method of any of claims 7-10, wherein the applying is separated from planting of the seed by a period of time.

12. The method of claim 11, wherein the period of time is at least a day.

13. The method of claim 7 or 8, wherein the applying comprises spraying, dipping, or coating at least a portion of the plant propagation material.

14. A method to enhance plant growth, crop quality, crop yield or a combination thereof comprising adding an effective amount of ethoxylated lecithin, or a composition comprising thereof, to a growth medium.

15. The method of claim 14, wherein the growth medium is a soil-based growth medium, a hydroponic growth medium, an aquaponic growth medium, or an aeroponic growth medium.

16. The method of claim 14 or 15, wherein the adding comprises irrigating, drenching, in-furrow application, spraying, or direct incorporation.

17. The method of any of claims 1-16, wherein the composition comprises about 0.01% v/v to about 99.9% v/v ethoxylated lecithin.

18. The method of claim 17, wherein the composition comprises about 0.01% v/v to about 10.0% v/v.

19. The method of any of claims 1-18, wherein the composition comprises a solvent, diluent, adjuvant, and/or other formulation aid.

20. The method of any of claims 1-19, wherein the composition further comprises one or more of a fungicide, an insecticide, a miticide, a nematicide, a fertilizer, a nutrient, a mineral, a hormone, a plant growth enhancer, and a stimulant.

21. A method to preserve health or stability of a plant or plant part post-harvest comprising providing an effective amount of ethoxylated lecithin, or a composition comprising thereof, to the plant or plant part.

22. The method of claim 21, wherein the plant part is selected from a fruit, a flower, flower petals, leaves, roots, tubers, seeds, cuttings, and combinations thereof.

23. The method of claim 21 or 22, wherein the providing comprises applying to the surface of the plant or plant part.

24. The method of any of claims 21-23, wherein the providing comprises fully or partially immersing the plant or plant part in the ethoxylated lecithin, or a composition comprising thereof.

25. The method of any of claims 21-24, wherein the ethoxylated lecithin, or a composition comprising thereof, is provided to the plant or plant part immediately preceding harvest or after harvest.

26. The method of any of claims 21-25, wherein the composition comprises about 0.01% v/v to about 99.9% v/v ethoxylated lecithin.

27. The method of any of claims 21-26, wherein the composition comprises about 0.01% v/v to about 10.0% v/v.

28. The method of any of claims 21-27, wherein the composition comprises a solvent, diluent, adjuvant, and/or other formulation aid.

29. A plant propagation material or seed treated with ethoxylated lecithin or a composition comprising thereof.

30. A growth medium comprising an effective amount of ethoxylated lecithin.

31. The growth medium of claim 30, wherein the growth medium is a soil-based growth medium, a hydroponic growth medium, an aquaponic growth medium, or an aeroponic growth medium.

32. Use of ethoxylated lecithin or a composition comprising thereof for improving plant growth or promoting plant health, comprising applying to a seed, or a plant, a plant part, a propagation material of the plant in an early stage of plant growth, or plant growth medium an effective amount of ethoxylated lecithin or a composition comprising thereof.

33. Use of a growth medium comprising an effective amount of ethoxylated lecithin for improving plant growth or promoting plant health.

34. Use of ethoxylated lecithin or a composition comprising thereof for preserving health or stability of a plant or plant part post-harvest.
